(19) United States
(12) Patent Application Publication
(10) Pub. No.: US 2014/0337372 A1
(43) Pub. Date: Nov. 13, 2014

(54) METHOD OF PROVIDING PROGRAM USING SEMANTIC MASHUP TECHNOLOGY

(71) Applicants: SAMSUNG ELECTRONICS CO., LTD., Suwon-si (KR); ELECTRONICS AND TELECOMMUNICATIONS RESEARCH INSTITUTE, Daejeon (KR)

(72) Inventors: Tae-dong LEE, Yongin-si (KR); Ki-ho KIM, Seongnam-si (KR); Yoo-mi PARK, Daejeon (KR); Hyun-joo BAE, Daejeon (KR); Hyun-kyung YOO, Daejeon (KR); Yu-chul JUNG, Daejeon (KR); Cin-young HUR, Daejeon (KR)

(73) Assignees: SAMSUNG ELECTRONICS CO., LTD., Suwon-si (KR); ELECTRONICS AND TELECOMMUNICATIONS RESEARCH INSTITUTE, Daejeon (KR)

(21) Appl. No.: 14/276,451

(22) Filed: May 13, 2014

Related U.S. Application Data
(60) Provisional application No. 61/822,491, filed on May 13, 2013.

(30) Foreign Application Priority Data
May 2, 2014 (KR) 10-2014-0053545

(51) Int. Cl. G06F 17/30

(52) U.S. Cl. CPC G06F 17/3097
USPC 707/767

(57) ABSTRACT

A method of providing a program is provided. The method includes: receiving a query of a user; semantically analyzing the query of the user; determining an intent of the user using an intent graph; recommending at least one service based on the determined intent; mashing up a selected at least one service in response to a service being selected with respect to the recommended at least one service; and providing a program generated by a result of the mashing up.

### CROSS-REFERENCE TO RELATED APPLICATIONS

This application claims priority from U.S. Provisional Patent Application No. 61/822,491, filed on May 13, 2013, in the United States Patent and Trademark Office, and Korean Patent Application No. 10-2014-0053545, filed on May 2, 2014, in the Korean Intellectual Property Office, the entire disclosure of which is hereby incorporated by reference in its entirety.

### BACKGROUND

1. Field

Exemplary embodiments relate to providing a mashup technology for producing a new application. In particular, exemplary embodiments relate to providing a mashup technology for mashing up several services based on a query of a program developer to produce a new application.

2. Description of the Related Art

1) Intent Understanding Technology

In a program development environment, a technology for properly understanding an intent of a developer is a very important factor to improve development productivity. In an environment where services are mashed up to develop a program, direct research on intent understanding has not been done, but research has been done on an information search field.

In a similar (web) search field, search logs of TV app developers are classified into a coarse-grained technique and a fine-grained technique. The Border reference [see i-1] has suggested that intents of a web TV app developer should be classified into navigational, informational, and transactional intents, and has derived various research [see i-2, i-3] related to a search goal of the web TV app developer. Among these, the Rose reference [see i-2] has suggested a taxonomy for further segmenting the Border reference. The Strohmaier reference [see i-5] has classified a query of a search log into an explicit intentional query category and an implicit intentional query category according to whether a verb exists in the query of the search log and classifies the query into two categories using n-gram and a quality of part of speech. The Shen reference [see i-4] has suggested a technique that classifies a query into 67 topic categories using a web search result.

In particular, a difference between a query of a TV app developer and a clicked website is expressed with a topic transition map (TTM) and is considered when ranking a plurality of subjects (or topics) to improve a quality of a search result. In this case, an open directory project (ODP) (www.dmoz.org) is used [see i-9].

A method of estimating a related action from a query including entities has been suggested [see i-6]. According to this method, a verb phrase level action that may be performed through the entities may be searched through a graph model-based probability inference. (e.g., “reading reviews, watching demo videos, and finding the best price online, etc.”).

Research for understanding an intent of a program developer is virtually nonexistent, and there is no attempt to connect a query, an intent, and a service through a feedback mechanism.

2) Semantic Service Matching Technology

A service mixing or mashup technology refers to a technology for mixing several unit services (programs) to produce a new application service. When mashing up services, information of a web service is basically used to calculate a relation (an interconnection) for a service connection. A type of a web service that is currently used on the Internet is classified into a Web Services Description Language (WSDL)-based web service and a RESTful service. The WSDL-based web service describes a service according to a standard form called WSDL to provide *.wsdl, but the described contents include only functional features (a service name, a service category, a service provider, a service description, a service goal, and an interface method/contents). Therefore, a matching technology for existing WSDL-based web services provides a static and/or dynamic matching method of comparing only interface information (including parameters) to secure interconnections between services. Also, using methods and contents of the RESTful services that are currently widely used are disclosed on web, but their expressions and descriptions are not consistent and unified according to providers due to nonstandard describing methods. It is impossible for a computer to automatically replace or connect disunified types of services through an algorithm. Therefore, WSMO [see j-1], OWL-S [see j-2], SAWSDL [see j-3] research has made efforts to semantically model functional and nonfunctional information of these to overcome differences in order to automatize service processing (searching, matching, mediating, etc.). However, the above research may not be applied to existing web services. The above research may be applied only if a new service is produced. Mixing of services currently connectable in most applications is determined in a design step and thus is difficult to be dynamically replaced in an exceptional situation. Also, only functional information of a service is used in attempts to dynamically enable this.

3) Ontology Evolution Technology

The ontology defines a relation between terms used in a particular domain to effectively share and use knowledge of the domain. The ontology may extract representative terms of the corresponding domain and may be established in a form of Resource Description Framework (RDF, http://www.w3.org/RDF), RDF Schema (RDFS, http://www.w3.org/TR/rdf-schema), Web Ontology Language (OWL, http://www.w3.org/TR/owl-features) by using relations between the corresponding terms and related words. Also, the ontology may be used in various fields such as information searches, artificial intelligence, web services, etc. An establishment and a management of the ontology are defined based on an expert of the corresponding domain or a dictionary of a corresponding field and relations between related terms and related words. However, as terms and attributes used in the domain are increased, and relations between terms become complicated, it is difficult to maintain and repair the ontology. Also, if a term describing a search keyword and a service is additionally defied when searching for a semantic service by using the ontology, the ontology may be manually complemented in consideration of a relation between a term and an attribute based on modeling of existing established ontology.

4) Gossip-Based Technology

Pareto's law or 80-20 rule refers to a phenomenon in which 80% of a total result occurs from 20% of a total cause. For example, this term is used to describe a phenomenon in which 20% customers shop by 80% of a total revenue of a department store. The same phenomenon occurs in a service included in mashup. In other words, this means that a service mainly used in the mashup converges into a part. For example, the service mainly used in the mashup may converge into Google™ Maps, Social, and an application programming interface (API) related to a search.

If closeness centrality concept is applied to this, a usage frequency of a service may be quantified. Closeness centrality is an inverse number of a sum of distances from one node to the other nodes. (see equation below). A more central node has a great inverse number. Closeness means how many times one service is used for mashup and thus helps quantitatively select this service. In addition, various services that are mixed with a service having high closeness may be inferred and thus may be useful reference data for developing a new mashup technology.

$${C}_{c} ( υ ) = \frac{1}{{\sum }_{t ∈ V}^{ } {d}_{G} ( υ , t )}$$

Closeness Equation (v: particular node, t: another node, d: distance between the particular node v and the another t).

As an example for managing information necessary for mashup, there is a centralized portal such as ProgrammableWeb [see m-3]. Functional and/or nonfunctional elements of a service are directly collected by a human, and a developer who wants to make mashup acquires various types of web service information from this portal. However, a web ecosystem, a style of a web service, and various embodiment technologies that quickly change, and frequently used particular services as mentioned above are required to be considered. If service providers configure and manage information of services provided by them through a common interface and a highly related service network, management cost of the services and mashup may be reduced, and mashup information may be dispersedly managed. Also, instead of managing information of all services, service providers may maintain only relations between services having high approximations to secure validity of mashup information.

For a mashup portal such as ProgrammableWeb, a human may track API changed points and mashup cases all the time. A message paradigm of a publication and/or subscription model may be applied between a service provider and a mashup portal or between the service provider and an individual mashup developer in order to automatically track and update latest information. The publication and/or subscription model is an asynchronous message paradigm and is not determined to transmit a message of a transmitter to particular receivers. Instead, a published message is characterized as a subject or contents. A subscriber displays an interest in one or more subjects. In this case, the subscriber receives only a message in which the subscriber displays an interest without any knowledge of a publisher. Decoupling between the publisher and the subscriber allows more dynamic network topology. In addition, if each node uses a gossip protocol [see m-5] that periodically transmits and receives meta information, extendability may be increased without a master managing the publisher and the subscriber. Therefore, the gossip protocol [see m-5] is appropriate for feature of different and distributed Internet services. The publisher and the subscriber may configure a network and apply a gossip protocol to distribute data. As a result, if a service provider distributes service information and a mashup network based on a gossip-based publication and/or subscription network, a mashup portal and a mashup developer may easily update valid latest information.

### REFERENCES

[i-1] A. Z. Broder, “A Taxonomy of Web Search”, ACM SIGIR Forum, vol. 46, pp. 3-10, 2002.
[i-2] D. E. Rose and D. Levinson, “Understanding User Goals in Web Search”, In Proc. of the 14th Int. Conf. of World Wide Web, pp. 13-19, 2004.
[i-3] A. Z. Broder, M. Fountoura, et al., “Robust Classification of Rare Queries using Web Knowledge”, In Proc. of the 30th annual Int. ACM SIGIR Conf. on Research and Development in Information Retrieval, pp. 231-238, 2007.
[i-4] D. Shen, R. Pan, et al, “Query Enrichment for Web Query Classification”, ACM Transactions on Information Systems (TOIS), vol. 24, no. 3, pp. 320-352, 2006.
[i-5] M. Strohmaier, P. Prettenhofer, M. Lux, “Different Degrees of Explicitness in Intentional Artifacts—Studying User Goals in a Large Search Query Log”, In Proc. of Int. Workshop on Commonsense Knowledge and Goal Oriented Interfaces, 2008.
[i-6] T. Lin, P. Pantel, et al., “Active Objects: Actions for Entity-centric Search”, In Proc. of the 21th Int. Conf. on World Wide Web, pp. 589-598, 2012.
[i-7] A. Jain and M. Pennacchiotti, “Domain-independent Entity Extraction from Web Search Query Logs”, In Proc. of the 20th Int. Conf. Companion on World Wide Web, pp. 63-64, 2011.
[1-8] X. Ling and D. S. Weld, “Find-Grained Entity Recognition”, In Proc. of AAAI 2012.
[i-9] Maeng seong-hyeon, Jeong yu-cheol, Kim kyeong-min, “Query/Document Subject Category Change Analysis System and Method and Query Extension-based Information Search System and Method Using the same”, [10-2009-0025759]
[i-10] Jeong yu-cheol, Bae hyeon-ju, Lee byeong-seon, “Service Goal Interpretation Apparatus and Method for Goal-based Semantic Service Discovery”, [10-2011-0126927]
[j-1] Web Service Modeling Ontology (WSMO), W3C Member Submission 3 Jun. 2005, Available at http://www.w3.org/Submission/WSMO/.
[j-2] Semantic Markup for Web Services (OWL-S), W3C Member Submission 22 Nov. 2004, Available at http://www.w3.org/Submission/2004/SUBM-OWL-S-20041122/.
[j-3] P. Sheth, K. Gomadam, and A. Ranabahu, “Semantics Enhanced Services: METEOR-S, SAWSDL and SA-REST,” IEEE Data Engineering Bulletin, vol. 31, no. 3, 2008, pp. 8-12.
[m-1] S. Yu, and J. Woodard. Innovation in the Programmable Web: Characterizing the mashup ecosystem. Workshop on Web APIs and Services Mashups, LNCS 5472, Springer, 136-147, 2008
[m-2] Closeness centrality, http://en.wikipedia.org/wiki/Centrality#Closeness_{—} centrality
[m-3] Programmable Web, http://www.programmableweb.com/[m-4]
[m-4] Publication/subscription model, http://en.wikipedia.org/wiki/Publish % E2%80% 93 subscribe_pattern
[m-5] Rahimian, F., Girdzijauskas, S., Payberah, A. H., Haridi, S.: Vitis: A gossip-based hybrid overlay for Internet-scale publish-subscribe. In: 2011 IEEE International Parallel and Distributed Processing Symposium, 2011.

### SUMMARY

Exemplary embodiments address at least the above problems and/or disadvantages and other disadvantages not described above. Also, the exemplary embodiments are not required to overcome the disadvantages described above, and an exemplary embodiment may not overcome any of the problems described above.

The exemplary embodiments may provide a method of mashing up a plurality of services.

According to an aspect of the exemplary embodiments, there is provided a method of providing a program. The method may include: receiving a query of a user; semantically analyzing the query of the user; determining an intent of the user by using an intent graph; recommending at least one service based on the determined intent; mashing up a selected service of the at least one service in response to a service being selected with respect to the recommended at least one service; and providing a program generated by a result of the mashing up result.

The semantically analyzing of the query the user may include: recommending an additional word that is used along with one word using lexicostatistics of web resources in response to the query of the user which comprises only the one word.

The semantically analyzing of the query of the user may include: recognizing the one named entity using a pattern-based heuristic and a statistical number.

The intent graph may be indicated by a selection probability of a service for a word included in the query of the user.

The determining the intent of the user may include: setting rankings in an order of a high selection probability of a service for a corresponding word of services which match a word included in the query of the user. The at least one service may be recommended based on the determined intent according to the set rankings.

The method may further include: changing the set rankings in consideration of the selected service of the at least one service to update the intent graph in response to the service being selected with respect to the recommended at least one service.

The intent of the user may be determined using the intent graph which corresponds to the user.

The method may further include: displaying the determined intent by using the intent graph. The intent graph may be updated in consideration of the selected service of the at least one service and the selected at least one intent in response to the service being selected with respect to the recommended at least one service and an intent being selected with respect to at least one of the displayed intent.

The recommending the service may include: recommending the at least one service and displaying the recommended at least one service as an icon.

The method may further include: searching for a service ontology and updating the service ontology using the selected at least one service and a word included in the query of the user in response to the service being selected with respect to the recommended at least one service.

The service ontology may be searched for and updated in consideration of the selected service of the at least one service and a related word of the word included in the query of the user.

The searching for and updating the service ontology may include: revising a relation value between a plurality of keywords and a keyword set of the service ontology in response to service selection information of the user, the plurality of keywords of the query of the user, and the keyword set of the service ontology matching each other; and generating a class of a keyword not matching the keyword set of the service ontology to add the class to the service ontology in response to the service selection information of the user, the plurality of keywords of the query of the user, and the keyword set of the service ontology matching each other.

The mashing up of the selected at least one service may include: reading the selected service of the at least one service from a registry and matching the selected service of the at least one service in response to the service being selected with respect to the recommended at least one service.

The service ontology may be searched for using the selected service of the at least one service and a word included in the query of the user, and a similarity between keywords searched from the service ontology being calculated and used for the matching.

The registry may store a plurality of services in a unified form based on functional feature information, nonfunctional feature information, and data feature information about the plurality of services.

The functional feature information may be at least one of a service name, a service category, a service provider, a service description, and a service goal, the nonfunctional feature information may be at least one of a transmission protocol, an authentication method, and a user evaluation, and the data feature information may be at least one of an input parameter and an output parameter.

The mashing up of the selected at least one service may include: calculating a relation between the plurality of selected services in response to a service being selected with respect to the plurality of services; and resolving the conflict in response to the conflict occurring between the plurality of selected services according to the calculated relation.

The mashing up of the service may include: calculating a compatibility of another compatible service in response to a user input for replacing one service of the plurality of selected services with the another compatible service.

The compatibility of the another compatible service may be calculated according to a compatible matrix.

The method may further include: revising the provided program according to a revision input of the user in response to the program generated by the result of the mashing up and the revision input of the user.

According to an aspect of the exemplary embodiments, there is provided a semantic service mashup system. The semantic service mashup system may include a semantic query analysis module configured to perform natural language processing with respect to a sentence or a compound word; an intent estimation module configured to acquire a verb level expression using a result of the natural language processing and an intent graph; and a service recommending module configured to recommend at least one service based on the verb level expression.

### BRIEF DESCRIPTION OF THE DRAWINGS

The above and/or other aspects will be more apparent by describing certain exemplary embodiments with reference to the accompanying drawings, in which:

FIG. 1 is a view illustrating a method of providing a program reflecting an intent of a developer and a system structure for performing the method;

FIG. 2 is a view illustrating a structure of an intent graph according to an exemplary embodiment;

FIG. 3 is a view illustrating an intent graph that is established based on a program developer's query and Twitter™ APIs, according to an exemplary embodiment;

FIG. 4 is a flowchart illustrating a process of estimating an intent by using an intent graph, according to an exemplary embodiment;

FIG. 5 is a view illustrating ranking of an intent considering an intent transition, according to an exemplary embodiment;

FIG. 6 is a flowchart illustrating a process of recommending and feeding back a service, according to an exemplary embodiment;

FIG. 7 is a view illustrating intent annotation of services, according to an exemplary embodiment;

FIG. 8 is a view illustrating a program developer's feedback after visualizing intent estimation results and recommended services, according to an exemplary embodiment;

FIG. 9 is a block diagram a structure for evolving a keyword ontology and calculating a similarity based on a usage feedback of a user to search for semantic services;

FIG. 10 is a flowchart of a method of searching for a related word of a keyword, according to an exemplary embodiment;

FIG. 11 is a flowchart of a function of adding a keyword and a relation, according to an exemplary embodiment;

FIG. 12 is a flowchart of a function of calculating a similarity between keywords, according to an exemplary embodiment;

FIG. 13 is a view illustrating a process of calculating a similarity between two keywords in a keyword ontology, according to an exemplary embodiment;

FIG. 14 is a view illustrating a configuration of a technology for generating and/or recommending a mashup logic through semantic service matching, according to an exemplary embodiment;

FIG. 15 is a flowchart a process of performing matching through technologies described in FIG. 14, according to an exemplary embodiment;

FIG. 16 is a view illustrating a method of calculating compatible service matching and interoperable service matching of FIG. 14, according to an exemplary embodiment;

FIG. 17 is a table illustrating web service metadata stored in a semantic service registry, according to an exemplary embodiment;

FIG. 18 is a table illustrating matching criterion applied to semantic service matching, according to an exemplary embodiment;

FIGS. 19 through 21 are views illustrating compatible service matching and interoperable service matching methods of FIG. 16 that are expressed as mathematical formulas, according to an exemplary embodiment;

FIG. 22 is a view illustrating a matrix for efficiently performing a type compatibility of compareParam, according to an exemplary embodiment;

FIG. 23 is a view illustrating tables indicating results of calculating compatibilities between a source service and a target service by using a CompareParam algorithm, according to an exemplary embodiment;

FIG. 24 is a flowchart of a process of detecting and resolving a conflict to increase a matching degree according to a result of calculating a relation between data features, according to an exemplary embodiment;

FIG. 25 is a table defining and providing type change functions to make parameter types compatible with each other if a compatibility value is 0.5 based on the matrix of FIG. 22, according to an exemplary embodiment;

FIG. 26 is a view illustrating a method of resolving a conflict, according to an exemplary embodiment;

FIG. 27 is a view illustrating a service provider that stores a mashup registration/publication/subscription interface and gossip information, according to an exemplary embodiment;

FIG. 28 is a view illustrating mashup registration/publication/subscription message types of a service provider, according to an exemplary embodiment;

FIG. 29 is a view illustrating various service providers and a mashup that is made of services hosted by the various service providers, according to an exemplary embodiment;

FIG. 30 is a view illustrating a process of propagating mashup information, according to an exemplary embodiment; and

FIG. 31 is a view illustrating a mashup network that evolves with time, according to an exemplary embodiment.

### DETAILED DESCRIPTION OF THE EXEMPLARY EMBODIMENTS

Exemplary embodiments are described in greater detail with reference to the accompanying drawings.

In the following description, the same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

A semantic service mashup method according to an exemplary embodiment includes: understanding an intent through a TV app developer's query and a feedback history, updating a service ontology by using a feedback and calculating a similarity between classes (which are terms constituting an ontology, words expressing a particular concept in a particular domain, keywords used for services defined as classes to establish the ontology, etc.) when searching for and matching services, calculating a relation between services and generating a mashup logic for increasing the relation when interconnecting or replacing selected services based on an understood intent, storing a developer's feedback on a mashup result in an internal history and using internal and external mashup histories for service mashup, and sharing gossip-based information between service providers to acquire the external mashup history.

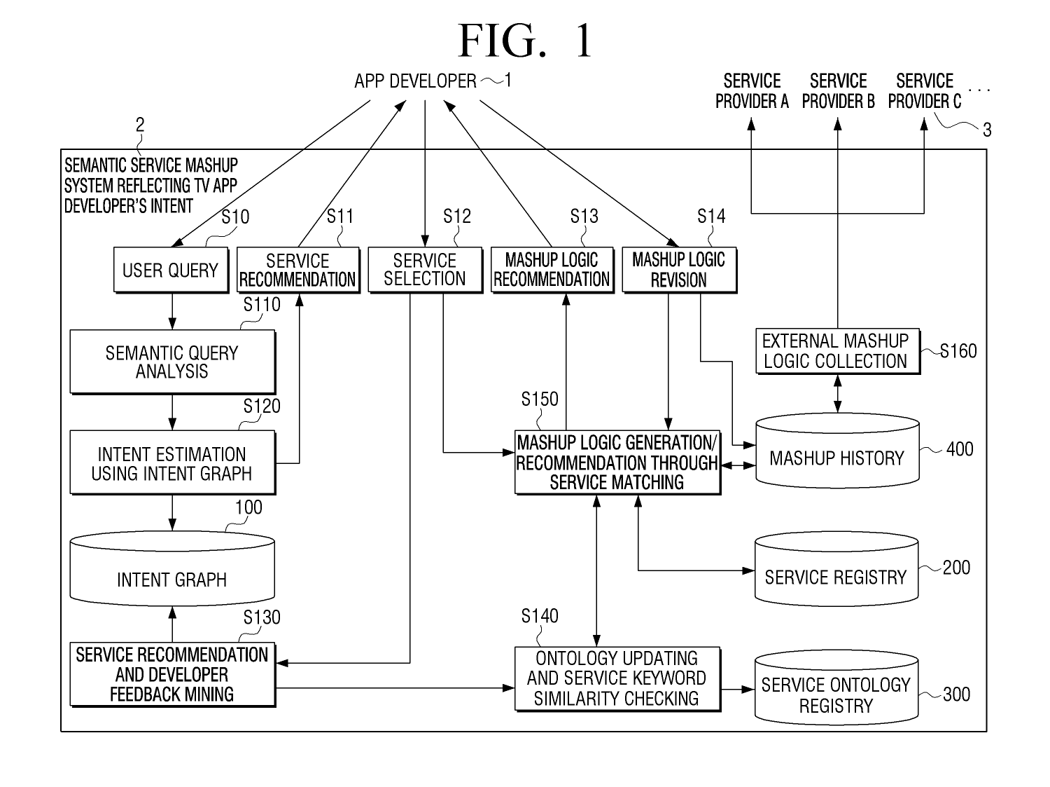

FIG. 1 is a view illustrating a method of providing a program reflecting an intent of a developer and a system structure for performing the method, according to an exemplary embodiment.

Referring to FIG. 1, in operation S10, an app developer 1 (e.g., a tv app developer) receives a user query through a semantic service mashup system 2. In operation S110, the app developer 1 semantically analyzes the user query. In operation S120, the app developer 1 determines (e.g., estimates) a user intent using an intent graph 100. In operation S11, the app developer 1 recommends services based on the determined intent. In operation S12, the app developer 1 selects at least one of the recommended services. In operation S130, the app developer 1 collects and mines program developer's feedbacks. In operation S140, the program developer's feedbacks (e.g., selection inputs) induce the intent graph 100 and a service ontology to be updated. If the app developer 1 selects the recommended services in operation S12, a mashup logic generator performs matching for smoothing interconnections between services in operation S150. In a matching process, service information is acquired from a service registry 200, a similarity between keywords defined in the ontology is calculated using an updated service ontology 300 and used for matching, and a logic is generated through a mashup history 400 with reference to internal and external mashup results in operation S150. If the generated mashup logic is provided to the app developer 1 in operation S13, the app developer directly revises and/or edits the mashup logic in operation S14.

Operations and elements of FIG. 1 will be summarized as follows.

Semantic Query Analysis (S110): A concept and entities that may be mapped are analyzed by performing natural language processing (morpheme analyzing, chunking, entity recognizing, etc.) with respect to a sentence or a compound word. Additionally, web resources for checking real world's latest terms may be connected (e.g., Wikipedia).

The intent graph 100 is a tripartite graph in which a program developer's query, a verb phrase level intent, and services are connected to one another, and connection probabilities between a query and an intent and between the intent and a service are updated through a feedback of the program developer.

Intent Estimation Using Intent Graph (S120): A verb phrase level expression that may be made by the program developer (e.g., a developer) is acquired using the intent graph for inputs of the acquired concept and entities. Ranking considering an intent transition is performed in the intent graph. The intent graph may be extensively connected to a goal taxonomy that is provided from an external source to improve a better performance and expand a domain.

The taxonomy classifies concepts of classes and instances into wider and detailed concepts, and hierarchically expresses the wider and detailed concepts. For example, there is relation “isA” for indicating an inclusion relation between concepts such as “Man is an animal.”

Non-taxonomy refers to a relation that is not taxonomy. For example, “Man keeps fit by exercising.” is expressed by using “cause” relation (a cause and effect relation).

Service Recommending and Developer's Feedback Mining (S130): Services that may achieve a verb phrase level program developer's intent are recommended to the program developer (e.g., the developer), and appropriate and/or inappropriate level feedbacks are acquired from the app developer 1 (e.g., a service is selected). An input and the feedback (a first query, a recommended service, and a final selection) of the program developer are used to update the intent graph.

Ontology Updating and Service Keyword Similarity Checking (S140): A keyword ontology is added based on a usage feedback to automatically evolve the ontology. Information about a targeted usage feedback that is managed by a service searching apparatus is acquired through a keyword frequently input from a service developer and keywords of a service selected according to a service search result in order to add the keyword ontology.

Service Ontology Registry (300): Keywords are arranged to have ranks of classes, and related words (e.g., synonyms, hypernyms, hyponyms) may be defined as an OWL file.

Mashup Logic Generation/Recommendation through Service Matching (S150): A mashup logic that may be connected to services selected by a user is generated. In this process, the service ontology 300, the service registry 200, and the mashup history 400 are used.

External Mashup Logic Collecting (S160): External (e.g., remote) mashup information is acquired according to a method of configuring a gossip-based publication and/or subscription network between service providers to accumulate and distribute information of a service having a high mashup frequency.

Service Registry (200): A service metadata storage that collects functional feature information (a service name, a service category, a service provider, a service description, a service goal, etc.), nonfunctional feature information (a transmission protocol, an authentication method, a user evaluation, etc.), data feature information (an input parameter, an output parameter, etc.) about existing (standard or nonstandard) web services that are widely used (regardless of an expression method) and stores the functional feature information, the nonfunctional feature information, and the data feature information in unified forms.

Mashup History (400): A registry (not program information and including service connection configuration) that stores service logics constituting a program generated by mashing up a plurality of services.

In the present specification, an intent and a goal are used as the same meaning.

Detailed processes of respective operations will now be described, and their usages will be described according to exemplary embodiments.

Semantic Query Analysis (S110): A sentence or a compound word may be analyzed as a concept, a goal, and entities that may be mapped through natural language processing (part of speech tagging, chunking, named entity recognition, etc.). In the semantic query analysis, two types of program developer's queries are processed using internal and/or external knowledge resources. A structure of an existing topic category (or taxonomy) is used, a rule-based heuristic is used, and usable statistical information, etc., are selected according to a type of a query to define a main concept of the query.

As described below, two types of queries are to be processed.

A first query may be formed of one or more words. One word brings about too many results and/or ambiguous results. In this case, additional (e.g., two or three) words that are used like the program developer's query are recommended using lexicostatistics of web resources (or a document set of a domain).

In a second query, if a named entity exists in the program developer's query, the named entity is recognized using pattern-based heuristic and a statistical number [see i-7] or by performing mechanical learning using resources such as external knowledge base (e.g., Wikipedia) [see i-8].

If a query is made with a verb phrase level explicit expression, an intent estimation using an intent graph 120 is immediately performed using a next step intent graph 100 that is expressed on a verb phrase level, without particular processing.

In general, two (or three) combined words may express a more detailed intent than one word. Also, if a particular name (a person name, a building name, an apparatus name, a country name, a company name, a software name, or the like) is immediately used, it is difficult to properly understand an intent of the program developer. Therefore, a disambiguation process for the named entities are required to be additionally performed. Any of the elements described above in the semantic service mashup system 2 and the service providers A through C may include at least one processor, a circuit, or a hardware module for performing their respective functions.

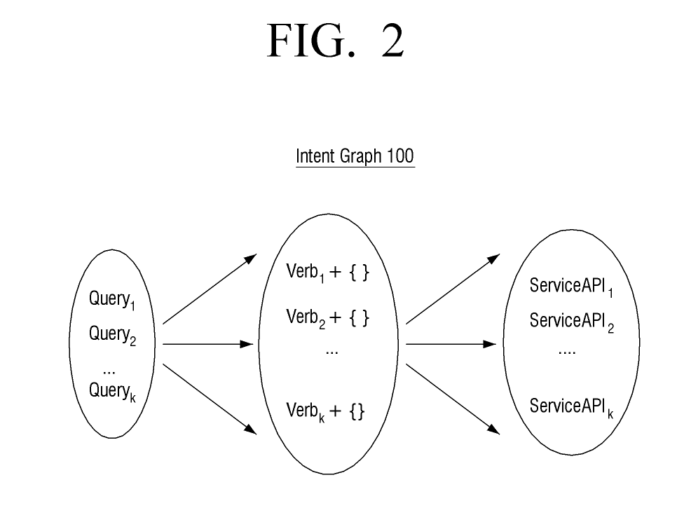

FIG. 2 is a view illustrating a structure of an intent graph according to an exemplary embodiment.

Intent Graph (IG) (100): The intent graph 100 is generated based on a usage log of the program developer. Since intents of services that are selected by the program developer are automatically (or semi-automatically) tagged, the services that are selected by the program developer in a feedback process may be expressed in a structure shown in FIG. 2. However, ServiceAPI refers to web services that are opened to common people by service providers such as Twitter™, Facebook™, Google™, etc. A click graph that is considered when searching for an existing general document does not include a middle stage intent part, and a service is mainly a selected webpage (or document).

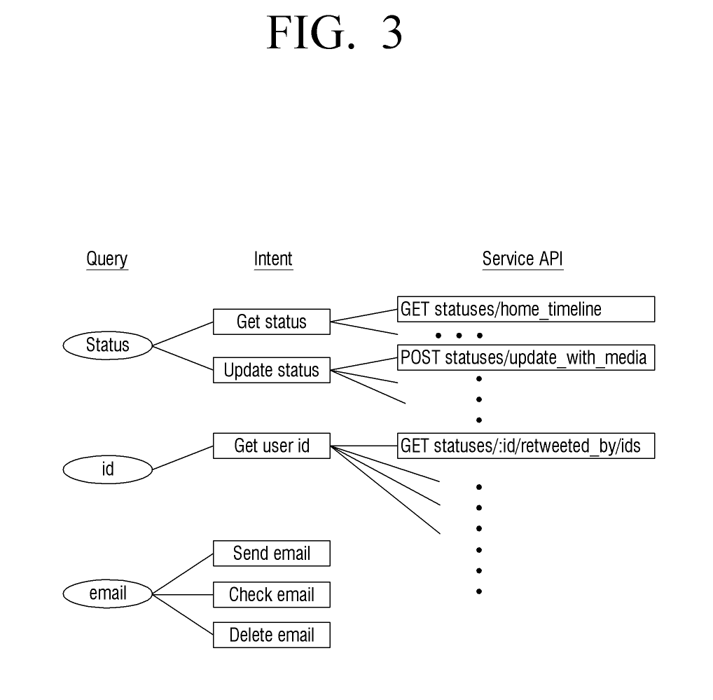

FIG. 3 is a view illustrating an intent graph that is established based on a program developer's query and Twitter™ APIs, according to an exemplary embodiment.

FIG. 3 illustrates a query and an intent that may be mapped to web services provided by the Twitter company. In the intent graph 100, connection probabilities between the query and the intents and between the intents and services are continuously updated by feedbacks of program developers. If lists of new services and intents are added to the intent graph, applications of the intent graph may be further extended.

Intent Estimation Using Intent Graph (S120): An established intent graph is searched for by using the concept acquired in the semantic query analysis as an input to be revised through a verb phrase level action that may be performed by the program developer (the developer). In particular, this step is a step of estimating an intent using an intent graph that is based on a case or history and an intent transition of a group (or an individual).

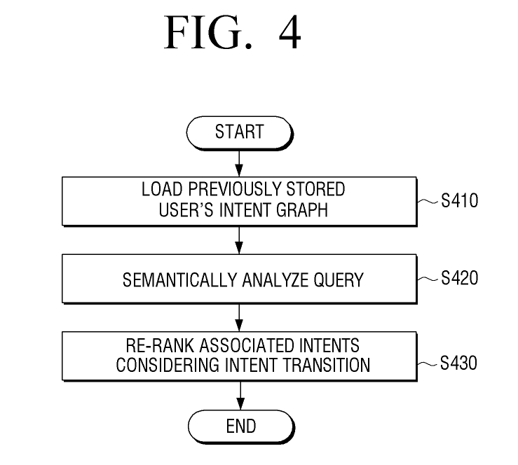

FIG. 4 is a flowchart of a process of estimating an intent using an intent graph, according to an exemplary embodiment.

Referring to FIG. 4, in operation S410, a previously stored user's intent graph is loaded to start an intent estimation using an intent graph. In operation S420, lists of a plurality of concept words as results of a semantic analysis of a program developer's query and a plurality of connected intents may be returned. This is finally ranked by a condition of the program developer, and the ranked intent is continuously used for the program developer in service recommendation and feedback processes. In particular, in the last ranking step, i.e., in operation S430, relatedness between intents extracted for considering an intention transition is calculated to perform ranking with reference to scores calculated for respective intents.

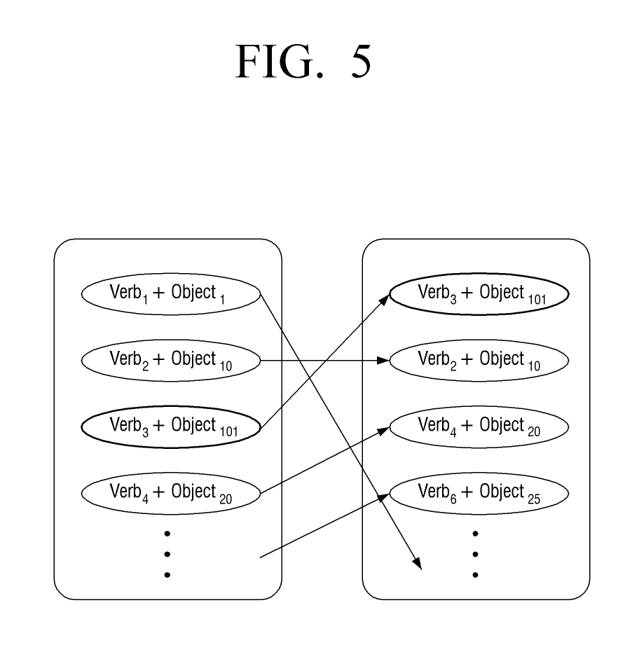

FIG. 5 is a view illustrating ranking of an intent considering an intent transition, according to an exemplary embodiment.

In a related art, research has been done to use a probability (e.g., a probability between a program developer's query and a clicked web document) that is calculated by logs (previous histories) accumulated in large quantities and use k upper highly related webpages. This case is a policy by which a target having a high statistical figure acquired through a log analysis is prioritized.

However, in the exemplary embodiments, an intent list is re-ranked according to an intent of the program developer changing with a log-based probability (an appearance probability between a program developer's query and a used service). A currently selected intent of the program developer is prioritized, and a potential intent of a selected service is reflected to change a ranking of a previously recommended intent list (refer to FIG. 3). For example, Verb₃+Object₁₀₁ selected by the program developer is ranked highest intent, and Verb₂+Object₁₀ and Verb₄+Object₂₀ which are determined as being similar to this are ranked second and third, respectively.

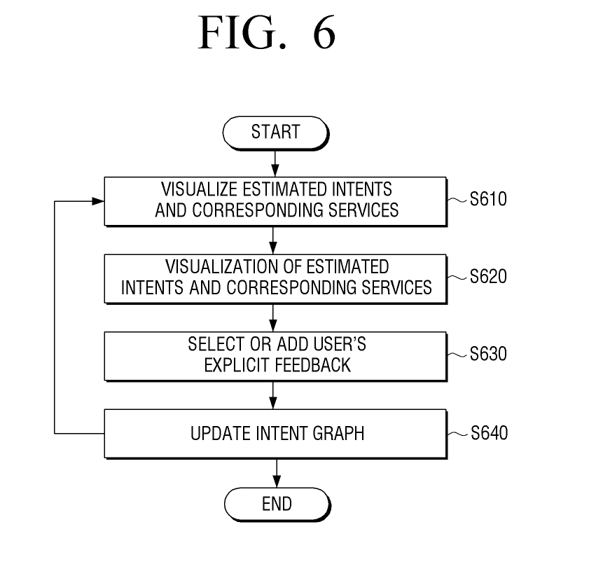

FIG. 6 is a flowchart of a process of recommending and feeding back a service, according to an exemplary embodiment.

Service Recommending and Developer's Feedback Mining (S130): Services for acquiring a verb phrase level program developer's intent are recommended to the program developer in operation 5610 to obtain a selection (or addition) level feedback from the program developer in operation 5630. In operation 5620, intent estimation results and corresponding services are visualized and shown. In operation 5640, an input and a feedback (a first query, a recommended service, a final selection, etc.) of the program developer are used to update the intent graph. Feedbacks of respective program developers on the same service may be different from one another, and verb phrase level goals may also be different from one another. Therefore, the service recommendation and developer's feedback ranking are processes for reflecting the differences.

Visualization of Intent Estimation Results and Recommended Services

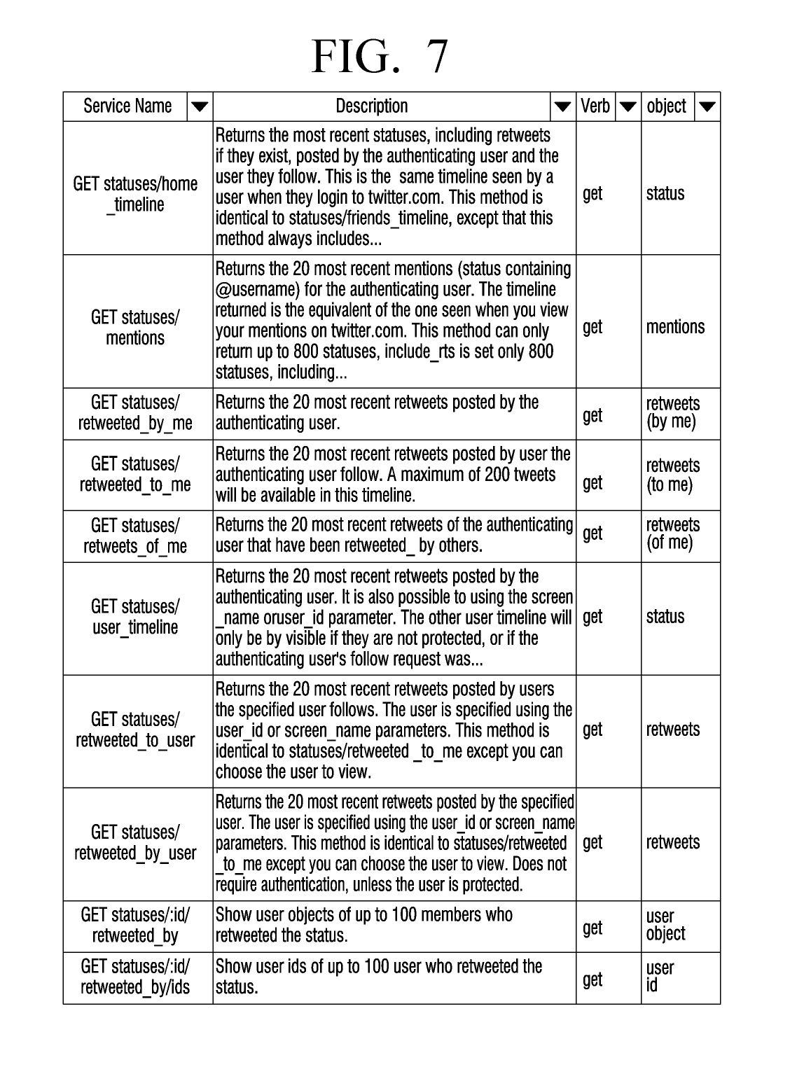

FIG. 7 is a view illustrating intent annotations of services, according to an exemplary embodiment.

After the intent estimation S120 using the intent graph, a service registry is searched to recommend a service matching a minutely checked intent of the program developer. As shown in FIG. 7, intent annotations are required to be made for services in order to recommend respective services.

The services may be recommended on a keyword matching level, but a considerable number of errors thereof may occur. Therefore, intents of services that are to be recommended may be analyzed [see i-10] to be maintained as meta information of the respective services. As a result, a search technique that complexly considers features of a keyword, an intent, and a topic category is used for a service that is recommended in consideration of the intent of the program developer.

Explicit Feedback (Selection or Addition) of Program Developer

A system may display an intent determined by using the intent graph. The program developer may select an intent that is currently targeted by the program developer, from a plurality of intents and recommended services and select a service meeting the selected intent, to explicitly express an intention of the program developer. In an existing feedback process, a target webpage (or document) is clicked. An intent and target services are all selected to provide an explicit feedback. If an intent considered by the program developer does not appear in a recommended intent list, a new intent may be added. A service is newly searched and visualized in consideration of a query and a newly selected intent. Therefore, an intent may be selected from a newly updated service list.

Updating of Intent Graph Through Feedback

The intent graph is extended and/or updated based on every feedback of the program developer. The intent graph is updated in consideration of feedbacks, and estimated intent results and recommended services that are acquired by the newly updated intent graph are re-visualized for the program developer. Therefore, as many feedbacks of the individual program developer exist, a high-quality intent graph is established.

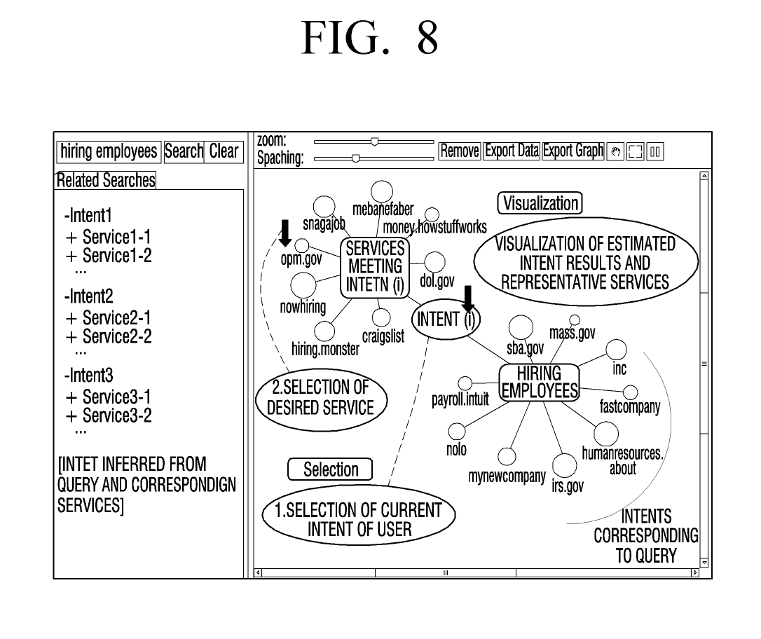

FIG. 8 is a view illustrating a program developer's feedback after visualization of intent estimation results of a query and recommended services, according to an exemplary embodiment.

A search function of searching for desired services through a query of a developer is provided, and a plurality of estimated intents and corresponding recommended services are respectively selected (or added) to provide a user's feedback.

Ontology Updating and Service Keyword Similarity Checking (S140)

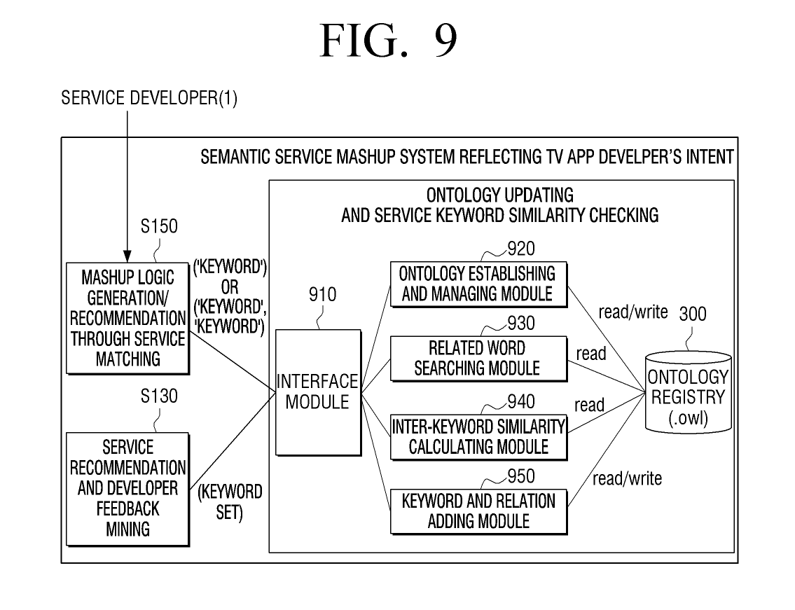

As shown in FIG. 9, an apparatus for evolving a keyword ontology includes an interface module 910, an ontology establishing and managing module 920, a related word searching module 930, an inter-keyword similarity calculating module 940, and a keyword and relation adding module 950. The interface module 910 receives a request from a service searching apparatus and transmits a result to the service searching apparatus. The ontology establishing and managing module 920 defines a similar word between keywords based on a service description and models hypernym and hyponym according to a hierarchical inclusion relation to generate and manage an OWL type ontology. The related word searching module 930 searches an ontology registry for a related word list including a similar word, hypernym, hyponym, and a lower component of an input keyword and provides the related word list. The inter-keyword similarity calculating module 940 calculates and provides a similarity value based on a relation between two keywords. The keyword and relation adding module 950 adds a keyword ontology based on a usage feedback on an input keyword and a frequently used service to evolve the ontology.

FIG. 9 is a block diagram illustrating a structure for evolving a keyword ontology and calculating a similarity based on a usage feedback of a user to search for a semantic service, according to an exemplary embodiment.

As shown in FIG. 9, the structure includes the interface module 910, the ontology establishing and managing module 920, the related searching module 930, the inter-keyword similarity calculating module 940, the keyword and relation adding module 950, and an ontology registry 300. The related word searching module 930 and the inter-keyword similarity calculating module 940 read data of the ontology registry 300 to process a request of a service searching apparatus. The ontology establishing and managing module 920 and the keyword and relation adding module 950 read and write ontology to generate and revise ontology.

The interface module 910 receives a request for calculating a keyword similarity from a function of generating and/or recommending a mashup logic through service matching and includes APIs providing a related word of the input keyword, a similarity calculating API, and a keyword and relation adding API. The APIs providing the related word of the keyword include APIs respectively providing a similar word, hypernym, hyponym, and a lower component, an API providing a hierarchical word of the similar word, the hypernym, and the hyponym, and an API providing all related words of the similar word, the hypernym, the hyponym, and the lower component. The similarity calculating API receives two keywords and calculate the shortest path depth of a keyword defined in the ontology registry to calculate and provide a similarity value. The keyword and relation adding API adds a keyword to existing ontology for a highly frequently searched keyword.

In search of a service for service mashup, a service having the same name as an input keyword is searched from a registry and then provided. The same meaning may be described as various terms according to service developers. Therefore, related words of a service keyword may be modeled through ontology to establish a keyword ontology, and related words of a keyword may be searched and provided when searching for a service to provide a further extended query result.

The ontology establishing and managing module 920 performs a process of extracting a related keyword based on functional semantic information about a service and a process of modeling the ontology according to categories of keywords to store the modeled ontology in the ontology registry 300. The functional semantic information about the service is a keyword, such as a service name, a service category, a service provider, a service description, a service providing country, etc., that is input when a service developer searches for the service. The ontology establishing and managing module 920 defines a similar word between keywords based on the keyword and models hypernym, hyponym, and a lower component according to a hierarchical inclusion relation to generate an OWL class type ontology.

If the keyword is input, the related word searching module 930 searches the ontology registry 300 for a class corresponding to the keyword and searches a whole ontology for a list defined as a keyword class and a related word (a similar word, hypernym, or hyponym) to provide an extended search result.

A keyword that directly defines a relation through a process of inferring ontology and a relation between keywords are extended by the inference. The service developer searches for a registered service based on the extended keyword to search for an intended service in order to use the intended service for mashup.

The inter-keyword similarity calculating module 940 receives two keywords and, if the two keywords are defined in the ontology registry and have a relation defined in the same OWL file, calculates the shortest path depth between the two keywords.

The inter-keyword similarity calculating module 940 designates a basic value acquired if the two keywords are connected as similar words or directly connected as hyponym and multiplies the basic value by a path depth number to calculate and provide a similarity value.

The keyword and relation adding module 950 adds the keyword ontology based on a usage feedback to automatically evolve the ontology. A targeted usage feedback acquires usage feedback information from the service recommendation and developer's feedback mining function S130 through a keyword highly frequently input by the service developer and keywords of a service selected by a service search result to add the keyword ontology.

The keyword and relation adding module 950 searches for the OWL file defining the corresponding keyword if a keyword set is defined in the ontology, updates a relation value between keywords if the keyword is pre-generated, and generates a keyword if the keyword is not defined to add a relation. If the keyword set is not defined in the ontology, the keyword and relation adding module 950 generates the OWL file, defines corresponding keywords as classes to generate the classes, and adds a relation between the keywords. The keyword and relation adding module 950 may automatically perform a keyword and relation adding function to evolve the ontology.

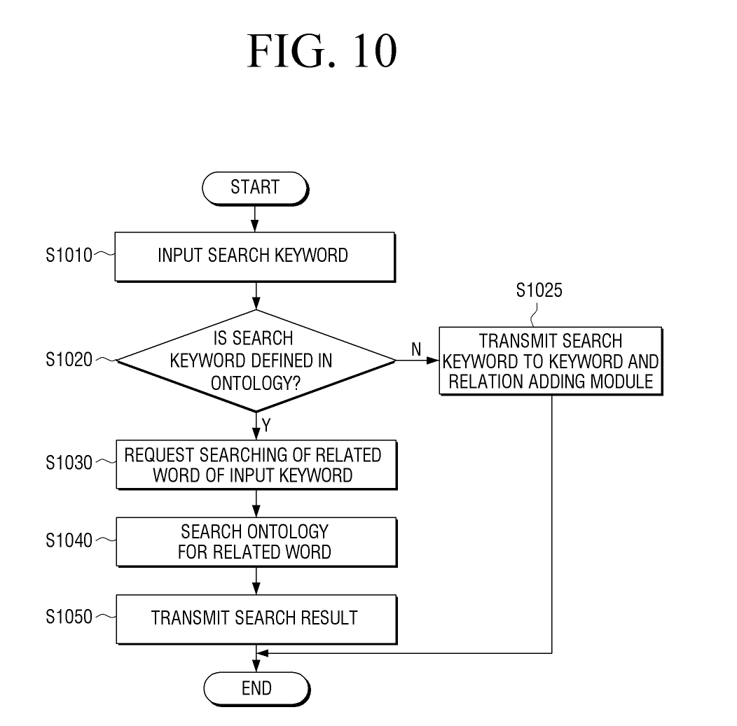

FIG. 10 is a flowchart of a method of searching for a related word of a keyword, according to an exemplary embodiment.

In operation S1010, a search keyword is input. In operation S1020, a determination is made as to whether the search keyword is a keyword defined in an ontology registry. In operation S1030, a related word of the keyword defined in the ontology registry is searched. If the search keyword is not defined in the ontology registry, the search keyword is transmitted to a keyword and relation adding module to check whether the search keyword is a keyword that is to be added in operation S1025.

In operation S1040, a class corresponding to the corresponding keyword is searched from the ontology registry to search for related word lists of a similar word class list, a hypernym class list, and a hyponym class list or all related words. In operation 51050, part of the attribute is defined in the hyponym class to search for a class that is a component of the hyponym and transmits the search result. An extended search result is provided through a relation that is directly defined through a reasoner and a relation that is defined through inferring.

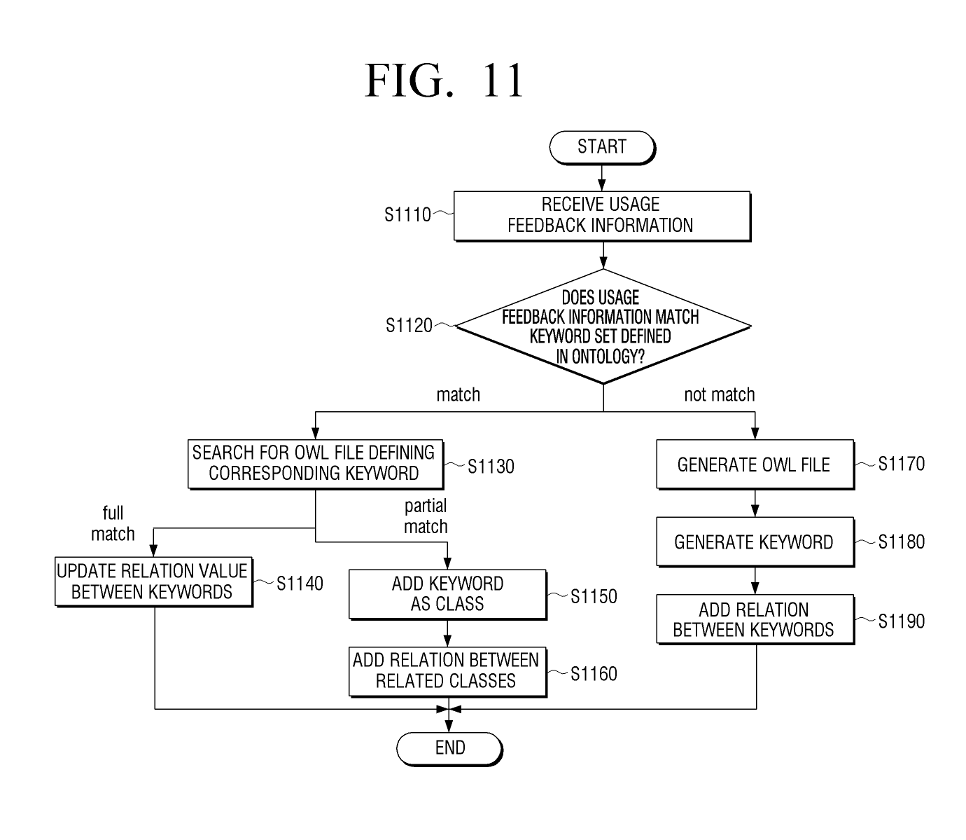

FIG. 11 is a flowchart of a function of adding a keyword and a relation, according to an exemplary embodiment.

In operation S1110, a search keyword and usage feedback information about a keyword of a highly frequently used service are received from a service searching apparatus. In operation S1120, whether the search keyword matches a related keyword set defined in an existing ontology is checked.

If the search keyword matches the keyword set defined in the existing ontology, an OWL file defining the corresponding keyword is searched in operation S1130. If the search keyword fully matches the keyword set defined in the existing ontology, a relation value between the corresponding keywords is updated in operation S1140. If the search keyword partially matches the keyword set defined in the existing ontology, a keyword that does not exist in the existing ontology is generated in a class form in operation S1150. In operation S1160, a relation between related classes is added.

If the search keyword does not match the keyword set defined in the existing ontology, an OWL file is generated in operation S1170. In operation S1180, the corresponding keywords are defined and generated as classes. In operation S1190, a relation between keywords is added. A keyword and a relation are automatically updated or generated to automatically evolve ontology.

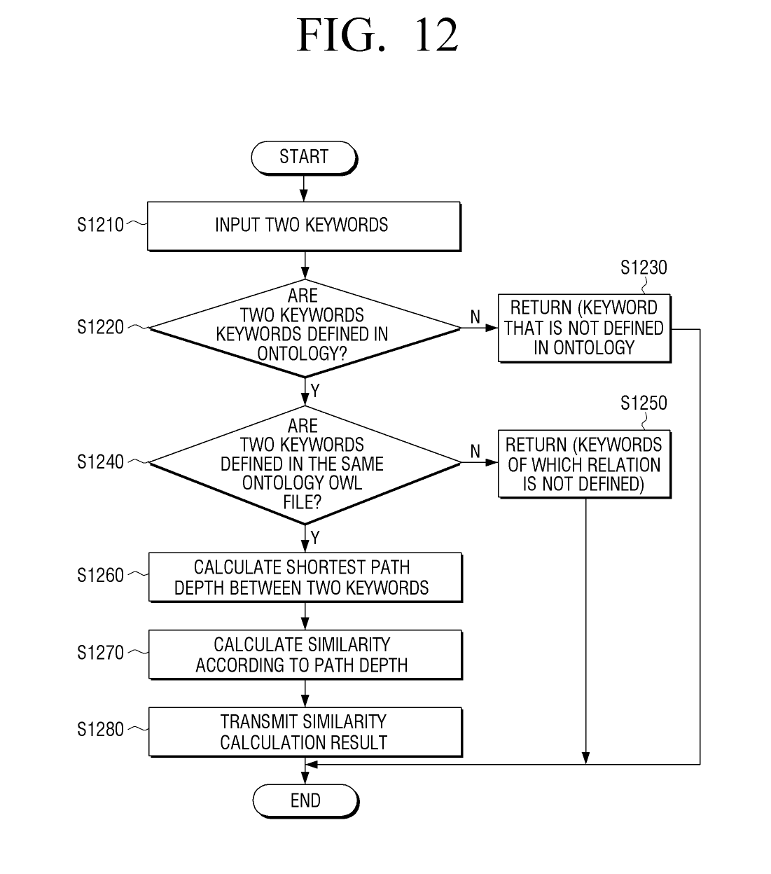

FIG. 12 is a flowchart of a function of calculating a similarity between keywords, according to an exemplary embodiment.

In operation 51210, two keywords that are respectively a source and a target are received. In operation S1220, whether the two keywords are defined in an ontology registry is checked. If the two keywords are defined in the OWL file, a similarity calculating function is performed in operation S1240. If the two keywords are not defined in the ontology, the two keywords return a notification that the two keywords are not defined in the ontology in operation S1230. If the two keywords are not defined in the OWL file, a message “A similarity between keywords is not defined” is returned in operation S1250.

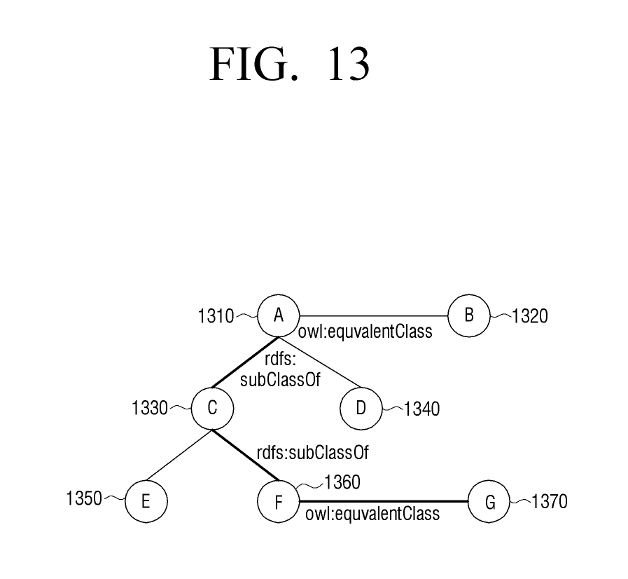

In operation S1260, the shortest path depth is calculated from a path that starts from a keyword that is a source in the corresponding OWL file and reaches a target keyword. In operation 51270, a similarity is calculated based on path depth. In operation S1280, the result value is transmitted. If two keywords KA and KB are connected as similar words (owl:equivalentClass), a weight value (Wequ) and hyponym (rdfs:subClassOf) are connected as a hierarchy, and a weight (Wh) and a path depth are n, a similarity between keywords is calculated based on the shortest path depth of a path that starts from a keyword A 1310 as a source and reaches a targeted keyword G 1370 (as shown in FIG. 13). An equation for calculating a similarity between keywords is shown below.

Similarity(A,G)=Πᵢ₌₁^{n(A,G)}Wi

where n(A, G): path distance between A and G, node i: node(s) on the path between A and G (1 £ i<n+1),

Similarity (A, G)=Wequ if owl:equivalentClass between node i and node(i+1),

Similarity (A, G)=Wsub if rdfs:subClassOf between node i and node (i+1).

The weight value of the similar word or hyponym connection may be optimized and used by a user according to a service search criteria. A similarity between the two keywords that are directly connected as the similar words or hyponym is higher than that between the two keywords that are connected through sibling having a connection relation by an inference.

FIG. 13 is a view illustrating a process of calculating a similarity between two keywords in a keyword ontology, according to an exemplary embodiment. In FIG. 13, a similar word connection relation between A 1310 and B 1320 is defined as owl:equivalentClass, and a hyponym connection between A 1310 and C 1330 is expressed as rdfs:subClassOf. Since the shortest path depth from A 1310 to G 1370 is A-C-F-G, a value of A-C relation is 0.9, a value of C-F relation is 0.8, and a value of F-G relation is 0.8, Similarity (A, G)=0.9*0.8*0.8=0.576.

Semantic Service Matching for Increasing Relation between Services (S150): Exemplary embodiments may provide a method of calculating and increasing a relation between a compatible service and an interoperable service by considering grammatically and semantically all functional and/or nonfunctional information opened on a web according to individual features thereof to replace the compatible service and the interoperable service with a smooth service connection.

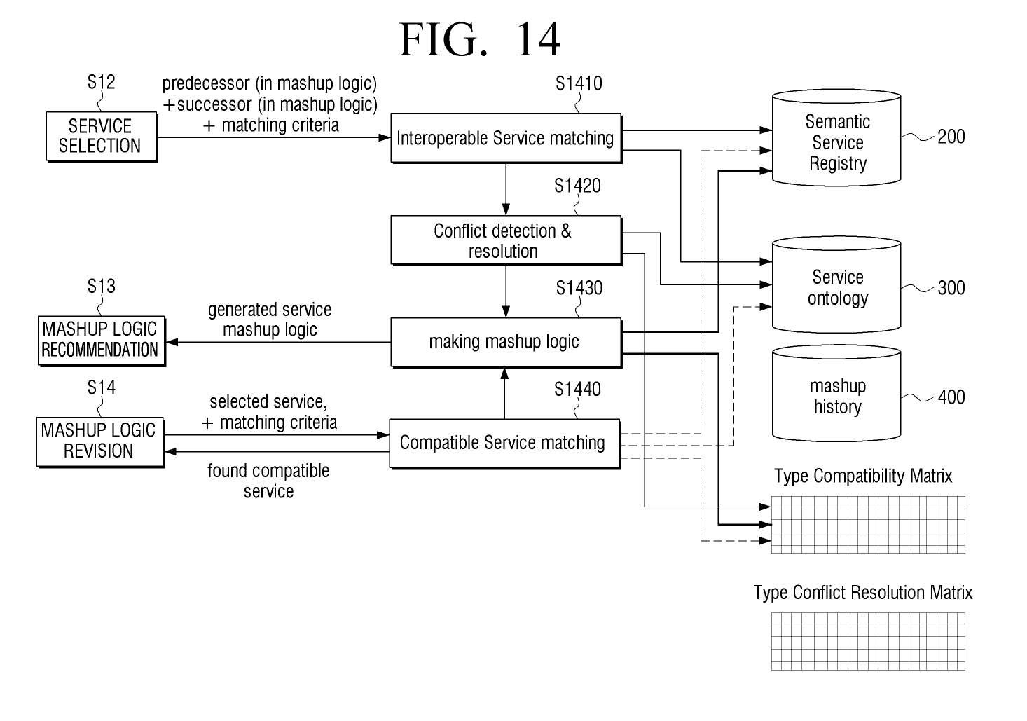

FIG. 14 illustrates a structure of a technology for generating and/or recommending a mashup logic through semantic service matching.

Interoperable Service Matching (S1410): Function of calculating an interconnection between a previous service and a subsequent service selected by a developer in a process of making a mashup logic

Conflict Detection and Resolution Suggestion (S1420): Function of recommending a method of searching for and solving a conflict to increase a relation (compatibility and an interoperability) between services in a mashup logic

Making mashup logic (S1430): Function of generating a mashup logic including relation information between services connected in a process of selecting and mashing up services according to an intent of the developer

Compatible Service Matching (S1440): Function of searching a service selected by the developer and an interoperable service to calculate a connection in a process of making a mashup logic

Type Compatibility Matrix: Compatible matrix for calculating matching of types of parameters of data features of a service

Type Conflict Resolution Matrix: Matrix including a method (library) of solving a conflict to improve a compatibility between types of parameters of a service

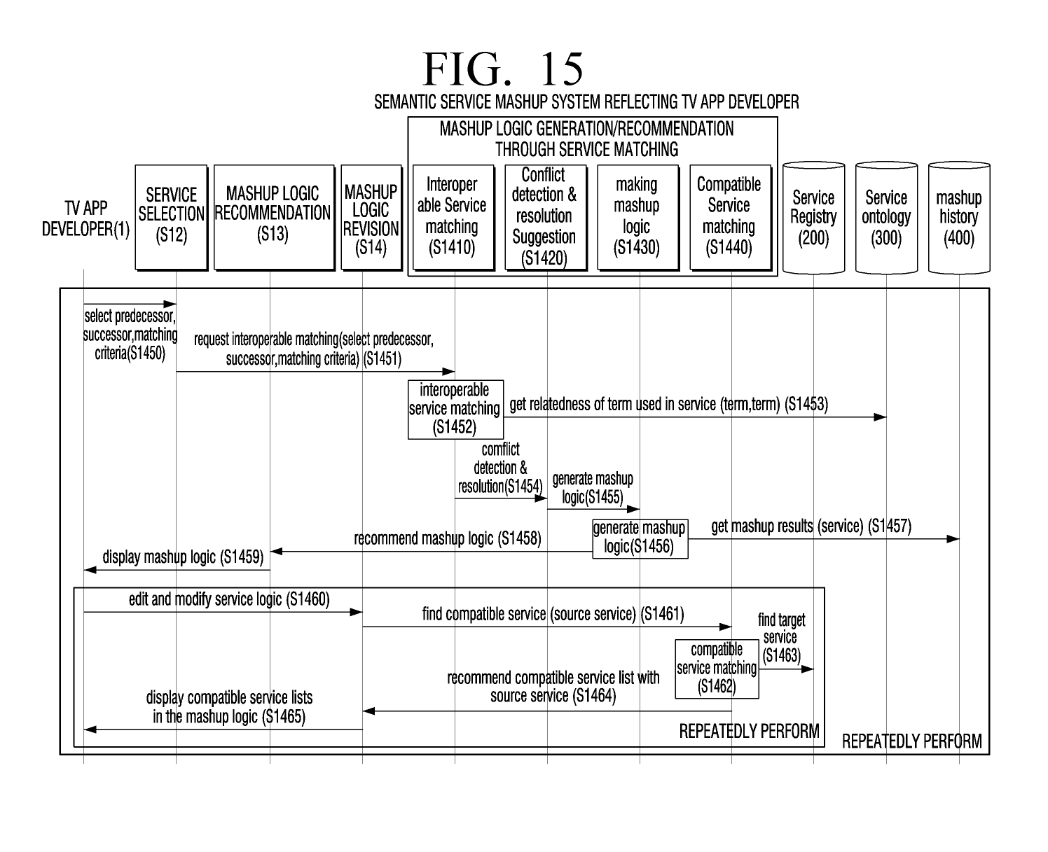

FIG. 15 is a flowchart of matching performed by technologies described with reference to FIG. 14.

If the program developer 1 selects a service in operation S12, calculating a relation is requested to connect a previous service and a subsequent service in operations S1450 and S1451. In operation S1453, an interoperable service matching function S1410 acquires similarity information through a service ontology in operation S1452 of calculating an interoperability between the previous service and the subsequent service. In operation S1456, a request is made to conflict detection & resolution suggestion S1420 to relieve and/or solve a conflict between input and output parameters after matching, and then a service mashup logic including matching and conflict relieving and/or resolving information is generated. In operations S1457, a mashup result including a service selected in this process is acquired to add the mashup result as a recommended service when generating the mashup logic. In operations S1458 and S1459, the mashup logic completed in relation to the service selection S12 of the developer is visualized and recommended to the developer.

The program developer may revise a returned service mashup logic. If a service of the mashup logic is to be replaced with another service in this process, a compatible service is requested through compatible service matching S1440 in operation S1461. Compatible service matching S1440 searches a service registry for target services to calculate a compatibility between a source service and a target service and return a target service list and a matching calculation result in operation S1464. If the returned result is visualized, the developer repeatedly performs the above-described operations S1460 through S1465 or S1451 through S1465 to complete the mashup logic.

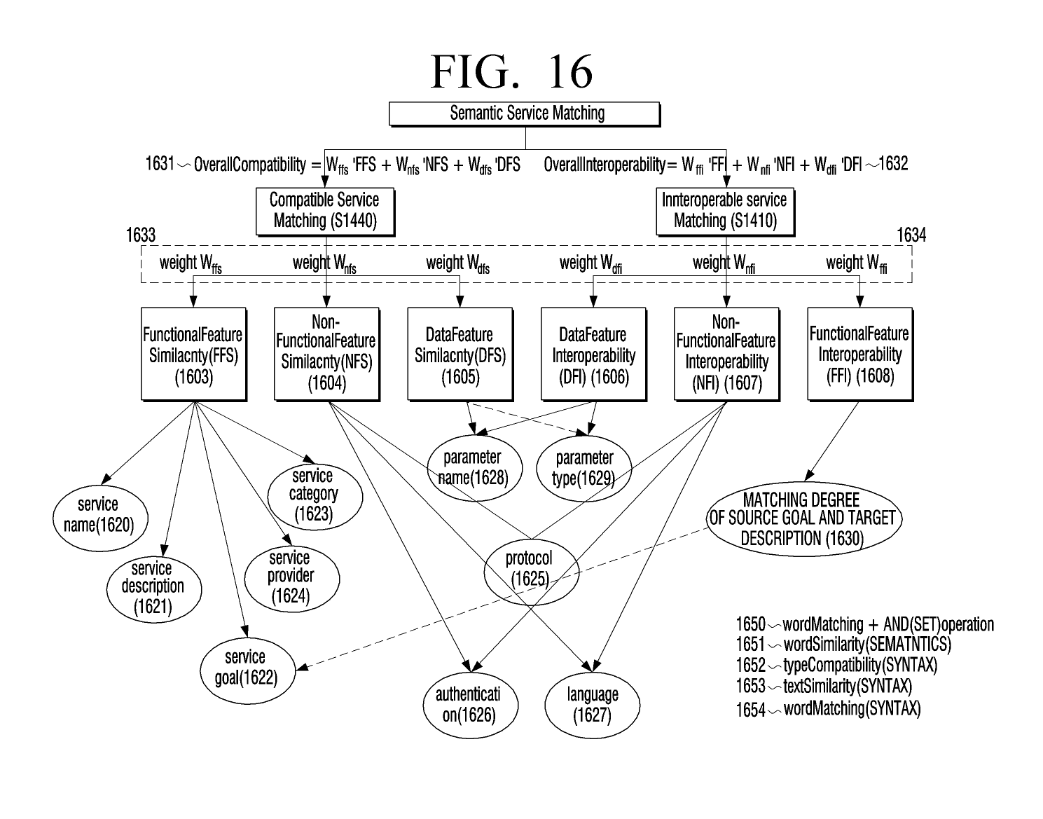

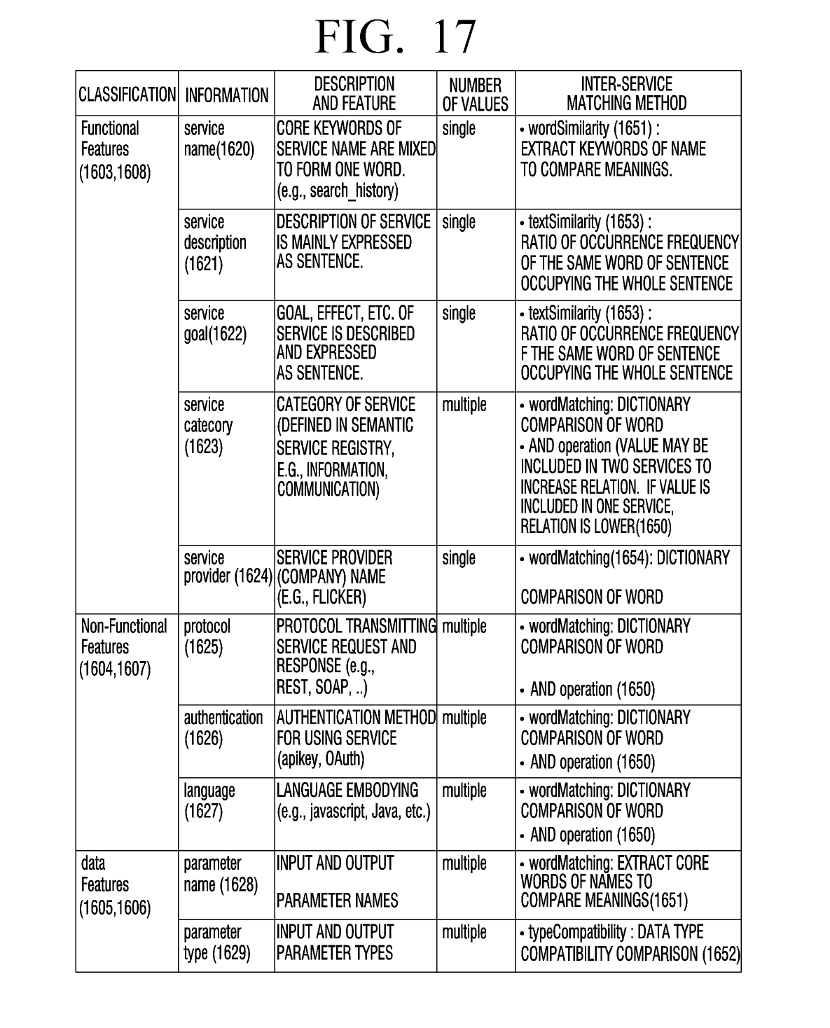

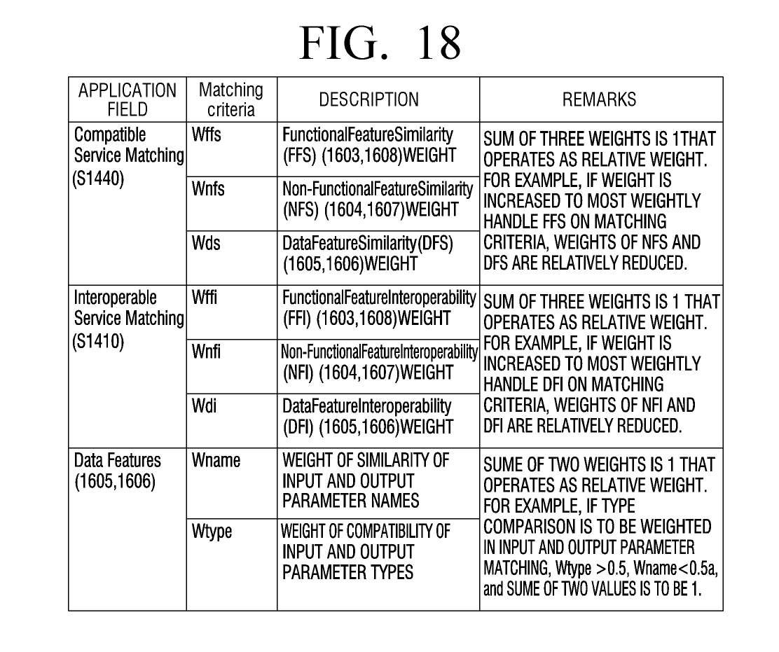

FIG. 16 is a view illustrating a method of calculating compatible service matching S1440 and interoperable service matching S1410 of FIG. 14, according to an exemplary embodiment. FIG. 17 is a table illustrating web service metadata stored in a service registry, according to an exemplary embodiment. FIG. 18 is a table illustrating matching criterion applied to semantic service matching, according to an exemplary embodiment.

Both of two methods individually perform comparison calculations appropriate for functional properties 1603 and 1608, nonfunctional properties 1604 and 1607, and data properties 1605 and 1606 of a service and apply corresponding weights 1633 and 1634 of matching criterion S1456 of FIG. 15 set by the developer to respective results to sum the respective results 1631 and 1632. Service information is stored in a sematic service registry, and comparison methods most appropriate for features of information are used for matching calculating as shown in the table of FIG. 17. Matching criterion will be described in the table of FIG. 18 below.

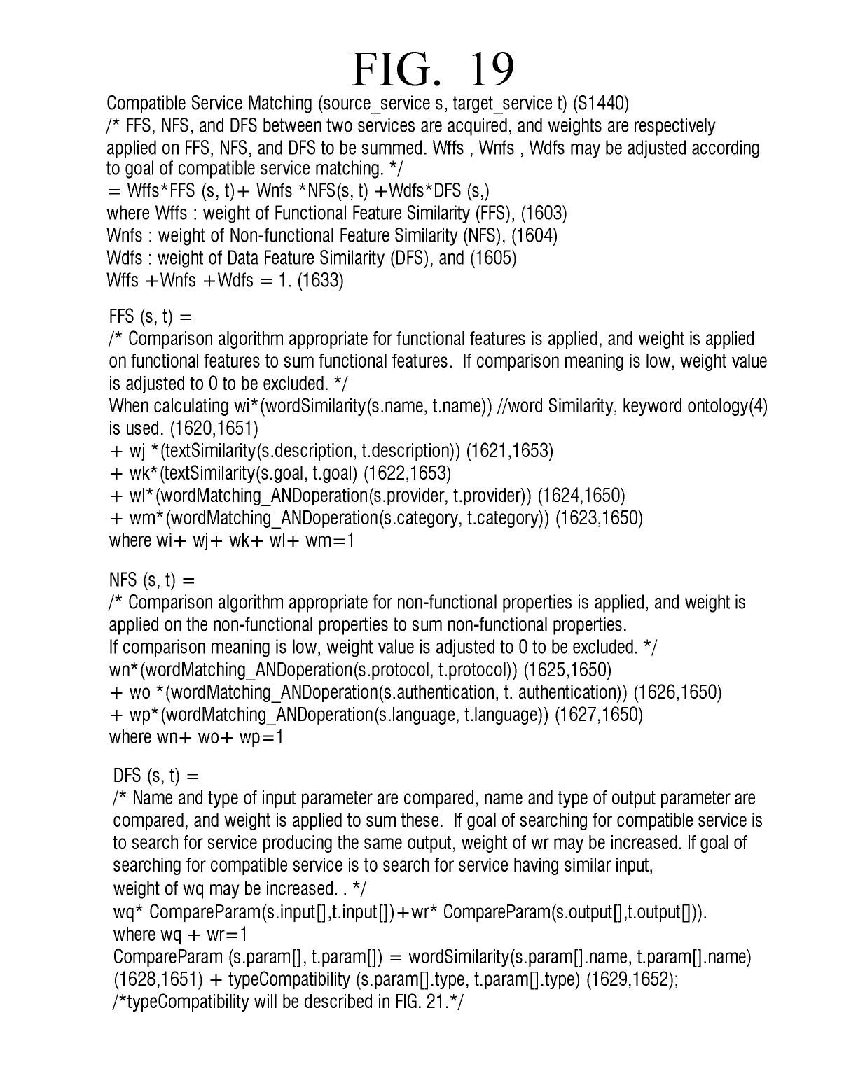

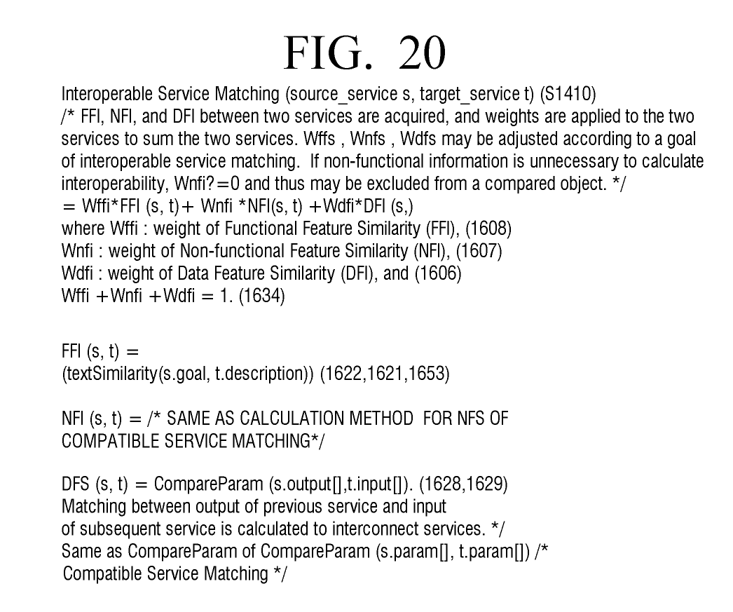

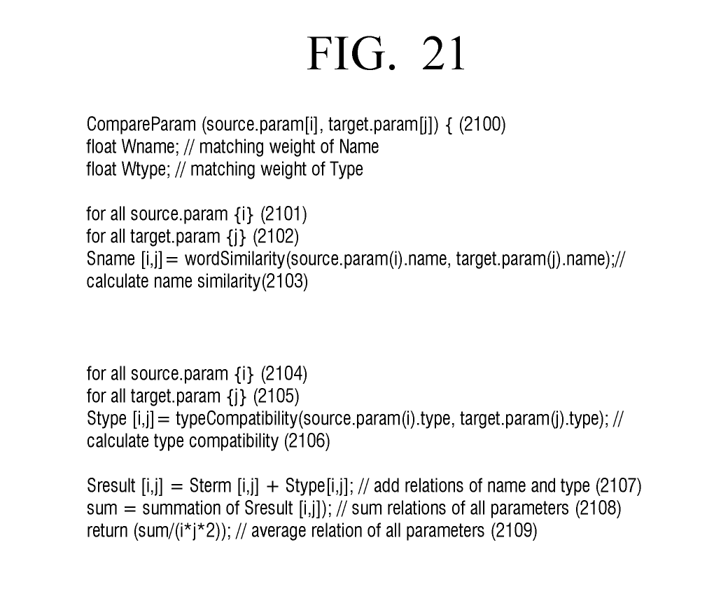

FIGS. 19 and 20 are views illustrating a compatible service matching method and an interoperable service matching method of FIG. 16 that are expressed as equations. FIGS. 20 and 21 are views illustrating a pseudo code of CompareParam that is a matching algorithm of a data feature (DFS, DFI) that is the most important factor of compatible service matching and interoperable service matching.

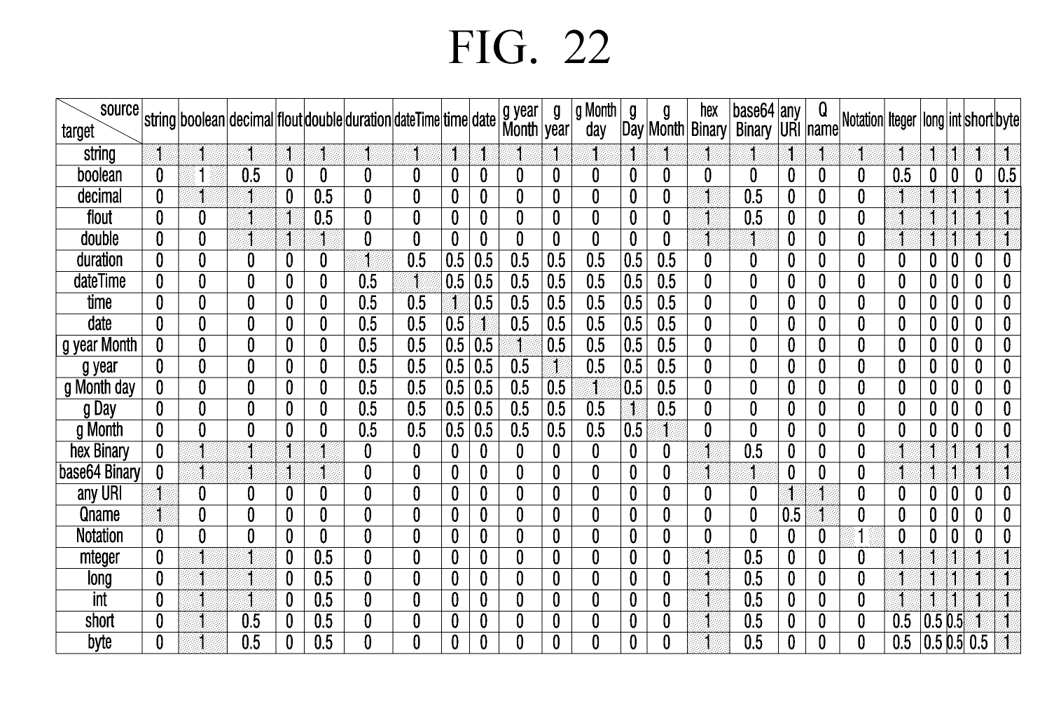

Relations between i input/output parameters 2101 and 2104 of a source service and j input/output parameters 2102 and 2105 of a target service are repeatedly calculated by i*j 2101, 2102, 2104, and 2105 to store a relation of a name in Sname [i,j] 2103 and store a compatibility of a type in Stype [i,j] 2106. If comparison calculation is completely ended, values of Sname [i,j] and Stype[i,j] are summed and then stored in Sresult[i,j] 2107. Sresult[i,j] stores a name between parameters between two services and a relation of types, all values of Sresult[i,j] cell are added 2108 and then divided by the total number of parameters 2109 to acquire an average value of the relation. A parameter name checks a semantic similarity comparison, and a parameter type checks a compatibility between types. A method of checking the compatibility between the types will be described by using a type compatibility matrix with reference to FIG. 22.

FIG. 22 illustrates a matrix for efficiently performing type compatibility of compareParam.

The matrix calculates a compatibility between types based on a primitive type through an XML schema (http://www.w3.org/TR/xmlschema-2/#atomic-vs-list) recommended by W3C. Each column denotes a parameter type of a source service, each row denotes a parameter type of a target service to which a source parameter is assigned, and a matrix value denotes a compatibility between two parameter types. A compatible value is divided into three steps, and if the compatible value is 1, the compatible value may be assigned without changing a type that is to be assigned from the source parameter to the target parameter. If the compatible value is 0.5, the compatible value may be assigned. However, a work for changing a type may be required according to a size of a memory in which the compatible value will be stored or an expression method of the compatible value. If the compatible value is 0, the type change is impossible, and thus the two types is not compatible with each other. For example, a time type of an eighth column of the matrix is not compatible with anyURI type of a seventh row, and thus a compatible value is 0. Also, a compatible value between anyURI type of a seventh column and a time type of an eighth row is 0. However, the matrix is not symmetric because the matrix has directivity that is to be assigned from a source to a target. For example, if a type of A is int, and a type of B is short, B may be assigned to A without any conditions (compatibility=1). However, if A is assigned to B, a front part of a memory of parameter A is lost, and thus another action is required when performing type changing (compatibility=0.5). TypeCompatibility matrix of FIG. 22 is not limited to XML schema, and an arbitrary data type (e.g., multimedia data, semantic data, or the like) may be added to columns and rows to extend the matrix.

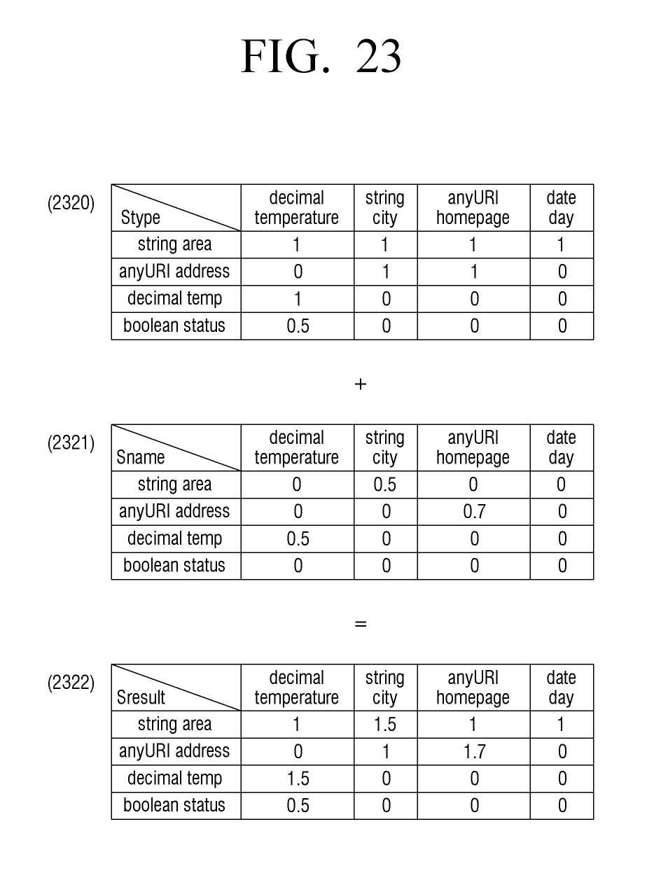

FIG. 23 is a table showing results of calculating compatibilities between a source service and a target source by using a CompareParam algorithm 2100. In the matrix, a first column is parameter of the target service, a first row is a parameter of the source service, and a value of each cell is a calculation result between Stype[i,j] 2320 and Sname[i,j] 2321 described in compareParame. Sname[i,j] calculates wordSimilarity 1651 through the keyword ontology 300, and Stype[i,j] calculates compatibility between types through the matrix of FIG. 22 to generate Sresult[i,j] 2107 and 2322 that is a sum of two matrixs. Finally, a total sum 9.2 (2108) of Sresult[i,j] is calculated to return value 9.2/32 (2109) acquired by dividing the total sum 9.2 (2108) by source parameter number (4)*target parameter number (4)*2(matrix)=32, as a result.

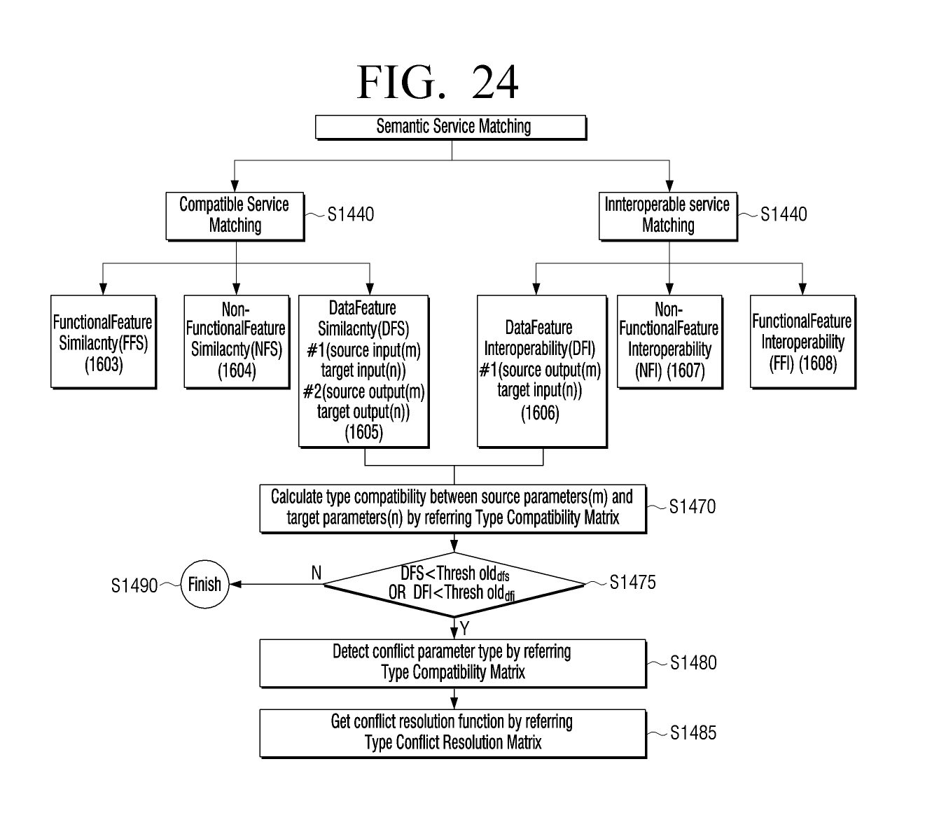

FIG. 24 is a flowchart of conflict detection and conflict resolution processes for increasing matching according to a result of calculating a relation between data features.

A method of detecting and resolving a conflict of semantic service matching is limited to data features 1605 and 1606. Although, a conflict is detected when matching functional features 1603 and 1608 and non-functional features 1604 and 1607, the conflict may not be resolved or does not need to be resolved. For example, as a result of matching compatibility between two services, descriptions or goals that are functional features match. Although service names or categories do not match, it is not necessary to resolve incompatibility between service names or categories to improve the compatibility between the two services.

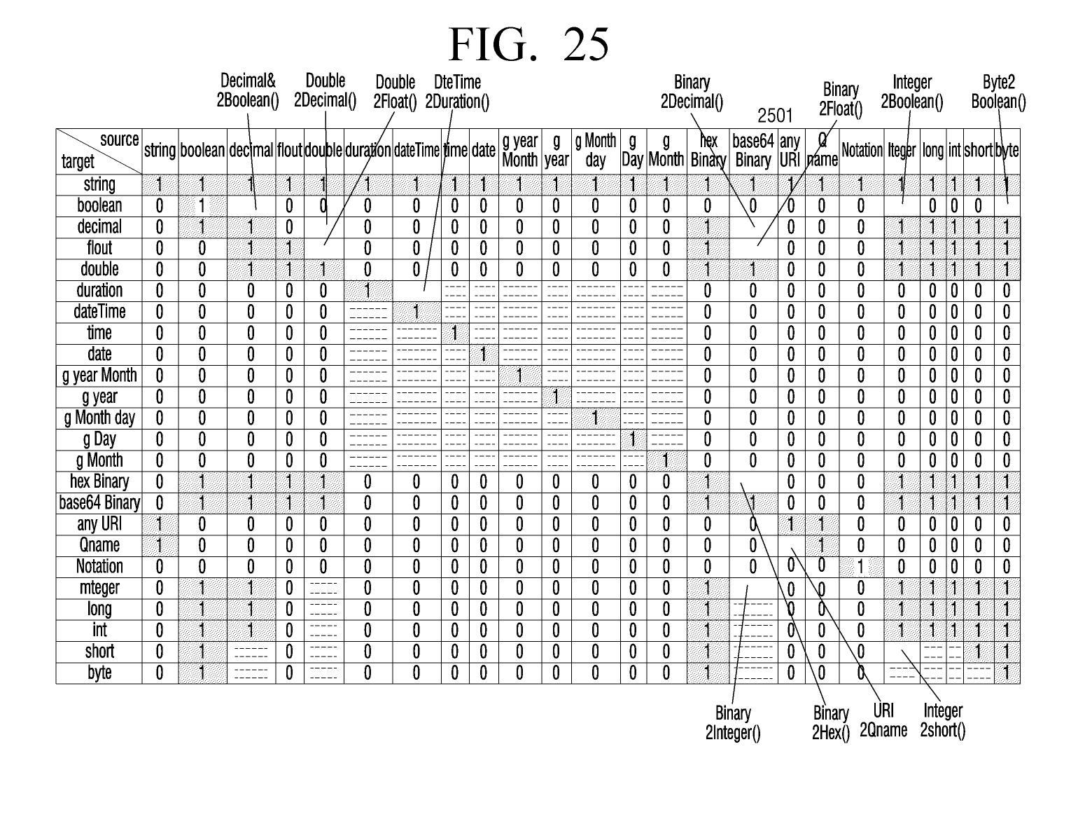

As a method of increasing a relation between services, there is a method of calculating compatibility of connected parameter types (S1480 of FIG. 22) when the relation is lower than a relation limit value (S1475-Y) and searching for a mixture of parameters by which a conflict may be resolved (S1485) to recommend an appropriate conversion function if a conversion function is provided. The appropriate conversion function is stored in the matrix of FIG. 25. If the relation is higher than a limit value, the conflict is not great. Thus, a matching work is finished without searching for a resolution method (S1490).

FIG. 25 illustrates a table defining and providing type conversion function to enable parameter types to be compatible with each other if a value of the matrix of FIG. 22 is 0.5.

There may be provided a method of providing a function for resolving a conflict between types detected through the matrix to increase compatibility or interoperability between services. Recommended functions are provided to a library together. For example, type compatibilities of an integer type 2500 of a 20^{th} column and base64Binary type 2501 of a 16^{th} row of the matrix is 0.5, and library Binary2Integer( ) 2502 that convers values of the type compatibilities are acquired with reference to a type conflict resolution matrix. The type conflict resolution matrix is applied to all parameters of service pairs that do not exceed a threshold value of a relation between two services to search for a conflict resolution library in order to return to a result. A data conversion library is output as an initial relation calculation value and a conflict resolution result on service matching view. The developer may be provided with a matching result and a conflict resolution function to easily replace or connect services. Some blanks marked with “-” are omitted.

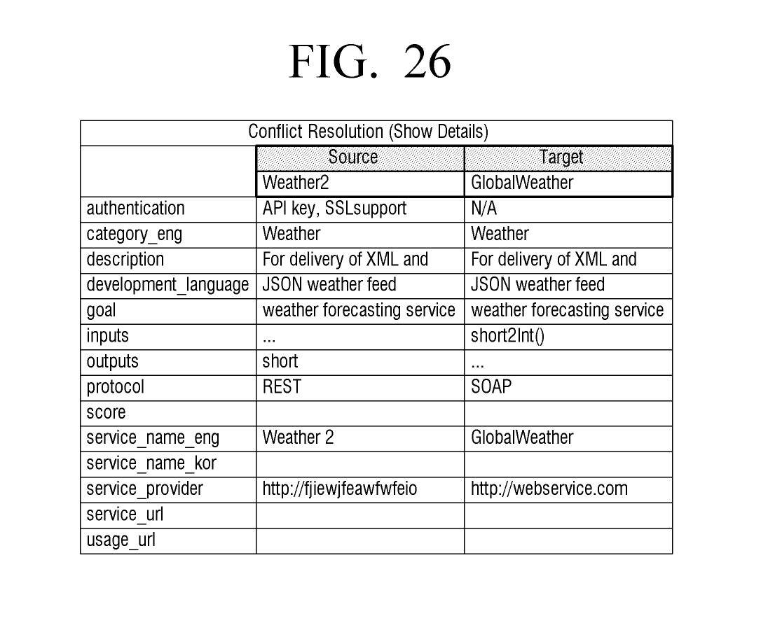

FIG. 26 is a view illustrating a method of resolving a conflict according to an exemplary embodiment.

If a source service is Weather2, a target service is GlobalWeather, and a short type of outputs of the source service Weather2 is assigned as an input parameter of the target service GlobalWeather, a library enabling a type conversion is added to resolve a conflict between two services. Short2Int( ) and resolution methods defined in FIG. 25 may be searched and displayed. The type conflict resolution matrix of FIG. 25 is not limited to the XML schema, and a data conversion library may be added to an arbitrary data type (e.g., multimedia data, semantic data, or the like) to extend the type conflict resolution matrix. A conflict resolution library and a resolution menu may be visualized differently from the present exemplary embodiment.

Method of Collecting Gossip-Based External Service Mashup Information (S160):

Exemplary embodiments may provide a method of ad hoc-connecting relations of services having high proximities based on gossips by a service provider to establish an echo system using a mashup application between the service provider and a consumer as a medium in order to reduce cost for managing mashup information through a central method and configure a service network securing latest and valid properties of the mashup information, thereby recommending the mashup information to generation of another mashup.

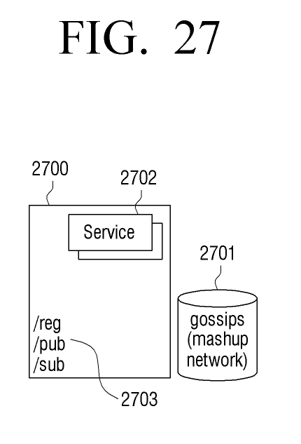

FIG. 27 is a view illustrating a service provider that stores a mashup registration/publication/subscription interface and gossip information according to an exemplary embodiment.

A service provider 2700 has an interface that hosts one or more services 2702 and registers/publishes/subscribes 2703 service information. The interface is used by mashup using services, a mashup portal subscribing information of services, a mashup developer, or the like. Another service that is mashed up is hosted by the same service provider or another service provider, and a gossip information registry 2701 includes only mashup information related to a corresponding service. If another service provider and a publication/subscription network are configured, gossip information may be exchanged.

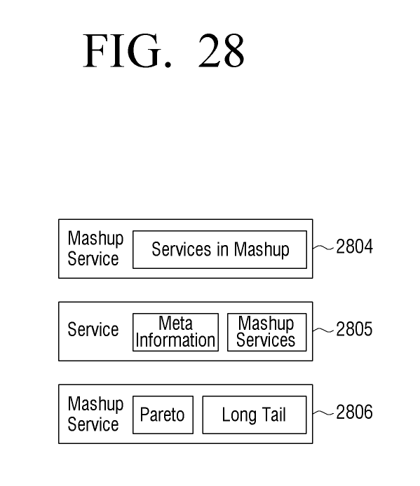

FIG. 28 is a view illustrating mashup registration/publication/subscription message types of a service provider according to an exemplary embodiment.

A mashup registration message 2804 displays information of a mashup service and information of individual services included in mashup. A mashup publication message 2805 includes meta information including a mashup number, an address, a request/response type, etc., of a service and information of another service mashed up with the corresponding service, based on contents acquired by analyzing a mashup network between services from mashup registration messages 2804. A mashup subscription message 2806 may differentially receive mashup information according to a particular criteria and helps in subscribing a service having a high mashup frequency according to Pareto's Law or various types of services having lower frequencies according to Long Tail Strategy.

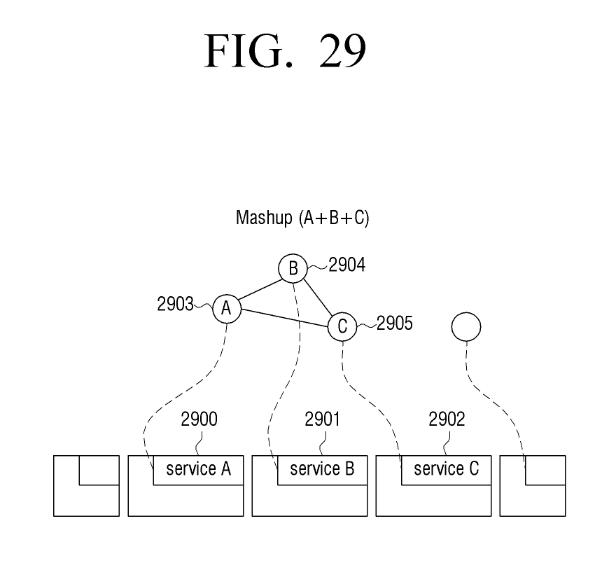

FIG. 29 is a view illustrating a mashup that is configured with various service providers and services hosted by the service providers according to an exemplary embodiment.

Services A 2900, B 2901, and C 2902 may be hosted by different service providers. A 2903 is a client calling the service A 2900, B 2904 is a client calling the service B 2901, and C 2905 is a client calling the service C 2902. The three clients A, B, and C configure one mashup service.

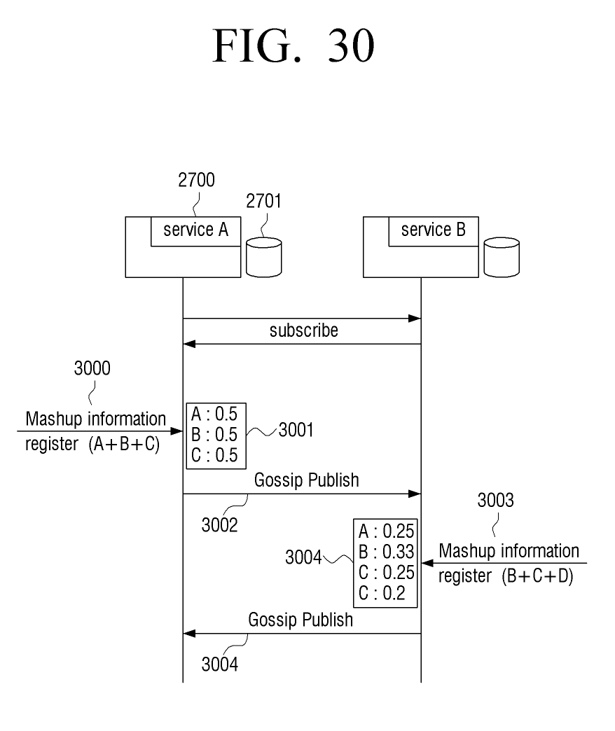

FIG. 30 is a view illustrating propagated mashup information according to an exemplary embodiment.

A service provider includes a service 2700 and a gossip information registry 2701. Service providers A and B publish and subscribe mashup information. In the present exemplary embodiment, services A and B are mashed up, and only providers of corresponding services may share mashup information. A service provider who receives mashup information 3000 including the service A updates information 3001 of another service in the gossip information registry. This information is published to another service provider 3002. Service information hosted by another service provider is excluded. A service provider who receives mashup information 3003 including the service B updates information 3004 of another service in the gossip information registry. This information is published to another service provider 3005. Closeness between other services is accumulated in each gossip registry and is propagated to another service provider. Although an access to any service provider is performed when developing a new mashup service, information of various services, including services that are most related to each other and services that are relatively less related to each other, may be acquired.

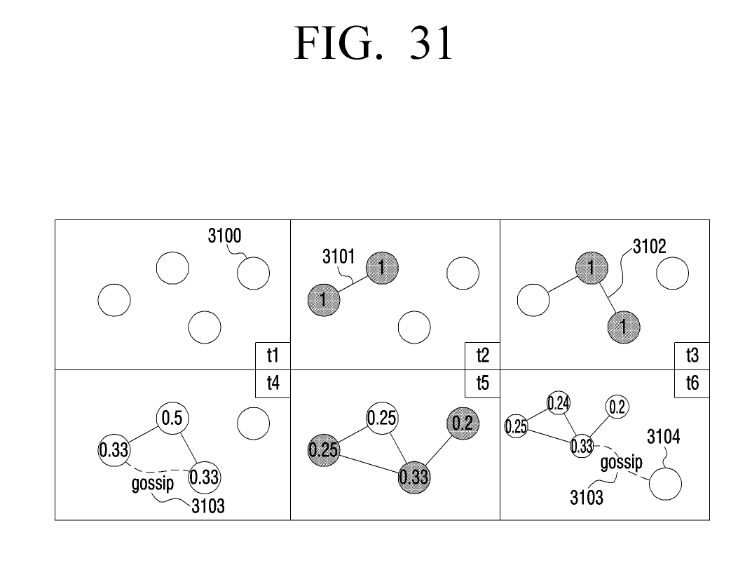

FIG. 31 is a view illustrating a mashup network that evolves with time, according to an exemplary embodiment.

Services 3100 may independently exist at time t1. Two services (marked with gray color) configures mashup at time t2. A publication/subscription network 3101 is formed between service providers respectively hosting services, and gossip in formation is shared. When new mashup is configured at time t3, a publication/subscription network 3102 is formed between two services (marked with gray color), and gossip information is shared. Gossip information 3103 is distributed between service providers on a publication/subscription network at time t4. At time t5, new mashup is configured. Thus, a publication/subscription network is configured between three services (marked with gray color), and re-calculated gossip information is updated. Although an access to any service provider of an existing network is performed when a new service 3104 is mashed up at time t6, gossip information 3103 about a service having high closeness may be easily acquired. Also, information of another service connected to the service may be acquired to be referred to for mashup

According to various exemplary embodiments described above, the following effects of the exemplary embodiments are described below.

Program Developer's Intent Detection Technique Using Intent Graph

The techniques have been suggested for a mashup service development environment requiring detailed intent understanding but may be applied to other types of several intelligent systems that accommodate other program developers' intent modeling and feedbacks and evolve. An intent category of a program developer that is to be understood and a service that is to be searched or a list of products may be replaced to extend and use the techniques.

Usage intents (or goals) of services that are automatically/semi-automatically tagged include potential errors, and the potential errors may be corrected through feedbacks of program developers.

A feedback of a program developer on visualization of a verb phrase level intent and recommendation of a related service may store/manage/use intents of the program developer through a further intuitive feedback. In an existing web search (or a search for other particular goals), a webpage (or a used service or book) corresponding to a program developer's query may configure a click graph through a click frequency thereof. However, this is insufficient to accommodate an explicit feedback of the program developer.

Services (e.g., web services or APIs) that are mapped on potential intents that are not embodied by an existing developer may be suggested, and then intent understanding may be performed through the feedback of the program developer. Therefore, efficiency of service search/recommendation for a highly ambiguous program developer's query may be improved.

Semantic Service Matching Technique Increasing Relation Between Interconnected Services:

A compatibility between data types may be automatically calculated by using an algorithm. Thus, connected services may be dynamically searched for and executed during execution. In other words, a computer may perform a work for searching for, replacing, and connecting appropriate services without human's intervention. Therefore, runtime service mashup is enabled.

The techniques may be applied to any field in which web services are to be mixed to develop applications, i.e., to any development environment such as a TV app, a mobile app, a desktop app, or the like. In addition, the techniques may be used as foundation techniques through which a general program developer may directly and dynamically mix services to make a new app

Ontology Updating and Checking of Keyword Similarity in Ontology

A function of receiving a feedback on list information about a search keyword input by a user and a service selected by the user to automatically update or add an ontology keyword in order to evolve ontology is to calculate a similarity between service keywords based on a service search and a usage pattern of the user changing in real time in order to support semantic processing of the service search and matching.

Method of Distributing Mashup Information to Gossip-Based Publication/Subscription Network to Establish Mashup History

Data that is acquired by quantifying a mashup number of services and relations with other services mixed together may be used to develop new mashup. Information is distributed only to providers of services included in mashup managing information of all services in a mashup portal and is not propagated to other service providers in order to reduce transmission cost. Mashup information of the present technology may show relations between services having high approximations to improve efficiency of the mashup information. According to the exemplary embodiments, a service provider may publish service information and a mashup network according to a publication/subscription model to enable a mashup portal and a mashup developer to easily and quickly update latest information.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method of providing a program, the method comprising:
receiving a query of a user;
semantically analyzing the query of the user;
determining an intent of the user using an intent graph;
recommending at least one service based on the determined intent;
mashing up a selected service of the at least one service in response to a service being selected with respect to the recommended at least one service; and
providing a program generated by a result of the mashing up.

2. The method of claim 1, wherein the semantically analyzing the query of the user comprises:
recommending an additional word that is used along with one word using lexicostatistics of web resources in response to the query of the user which comprises only the one word.

3. The method of claim 1, wherein the semantically analyzing the query of the user comprises:
recognizing one named entity using a pattern-based heuristic and a statistical number in response to the query of the user comprising a word indicating the one named entity.

4. The method of claim 1, wherein the intent graph is indicated by a selection probability of a service for a word comprised in the query of the user.

5. The method of claim 1, wherein the determining the intent of the user comprises:
setting rankings in an order of a high selection probability of a service for a corresponding word of services which match a word comprised in the query of the user,
wherein the at least one service is recommended based on the determined intent according to the set rankings.

6. The method of claim 5, further comprising:
changing the set rankings in consideration of the selected service of the at least one service to update the intent graph in response to the service being selected with respect to the recommended at least one service.

7. The method of claim 1, wherein the intent of the user is determined using the intent graph which corresponds with the user.

8. The method of claim 1, further comprising:
displaying the determined intent using the intent graph,
wherein the intent graph is updated in consideration of the selected service of the at least one service and a selected at least one intent in response to the service being selected with respect to the recommended at least one service and an intent being selected with respect to at least one of the displayed intent.

9. The method of claim 1, wherein the recommending the at least one service comprises:
recommending the at least one service and displaying the recommended at least one service as an icon.

10. The method of claim 1, further comprising:
searching for a service ontology and updating the service ontology using the selected at least one service and a word comprised in the query of the user in response to the service being selected with respect to the recommended at least one service.

11. The method of claim 10, wherein the service ontology is searched for and updated in consideration of the selected service of the at least one service and a related word of the word comprised in the query of the user.

12. The method of claim 10, wherein the searching for and updating the service ontology comprises:
revising a relation value between a plurality of keywords and a keyword set of the service ontology in response to service selection information of the user, the plurality of keywords of the query of the user, and the keyword set of the service ontology matching each another; and
generating a class of a keyword not matching the keyword set of the service ontology to add the class to the service ontology in response to the service selection information of the user, the plurality of keywords of the query of the user, and the keyword set of the service ontology matching each another.

13. The method of claim 1, wherein the mashing up the selected at least one service comprises:
reading the selected service of the at least one service from a registry and matching the selected service of the at least one service in response to the service being selected with respect the recommended at least one service.

14. The method of claim 13, wherein the service ontology is searched for using the selected service of the at least one service and a word comprised in the query of the user, and a similarity between keywords searched from the service ontology being calculated and used for the matching.

15. The method of claim 13, wherein the registry stores a plurality of services in a unified form based on functional feature information, nonfunctional feature information, and data feature information about the plurality of services.

16. The method of claim 15, wherein the functional feature information is at least one of a service name, a service category, a service provider, a service description, and a service goal,
wherein the nonfunctional feature information is at least one of a transmission protocol, an authentication method, and a user evaluation, and
wherein the data feature information is at least one of an input parameter and an output parameter.

17. The method of claim 1, wherein the mashing up the selected at least one service comprises:
calculating a relation between a plurality of selected services in response to a service being selected with respect to the plurality of services; and
resolving a conflict in response to the conflict occurring between the plurality of selected services according to the calculated relation.

18. The method of claim 17, wherein the mashing up the selected at least one service comprises:
calculating a compatibility of another compatible service in response to a user input for replacing one service of the plurality of selected services with the another compatible service.

19. The method of claim 18, wherein the compatibility of the another compatible service is calculated according to a compatible matrix.

20. The method of claim 1, further comprising:
revising the provided program according to a revision input of the user in response to the program generated by the result of the mashing up and the revision input of the user.
